(19) United States
(12) Patent Application Publication
(10) Pub. No.: US 2010/0072892 A1
(43) Pub. Date: Mar. 25, 2010

(54) HEATER LAMP

(75) Inventors: Akio Watanabe, Ehime-ken (JP); Tetsuo Ootani, Ehime-ken (JP); Seiji Sakamoto, Ehime-ken (JP); Minoru Nishizono, Ehime-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Harison Toshiba Lighting Corp, Ehime (JP)

(21) Appl. No.: 12/443,085

(22) PCT Filed: Sep. 21, 2007
(86) PCT No.: PCT/JP2007/068418

§ 371 Date: Jun. 12, 2009

(30) Foreign Application Priority Data
Sep. 26, 2006 (JP) 2006 260965
Nov. 28, 2006 (JP) 2006 319901
Feb. 14, 2007 (JP) 2007 033858
Feb. 23, 2007 (JP) 2007 043894

(51) Int. Cl. H01J 61/36; H01K 1/50; H01J 9/00; G03G 15/20

(52) U.S. Cl. 313/579; 445/27; 313/623; 399/328

(57) ABSTRACT

A halogen lamp including a glass bulb, a filament inserted inside the bulb, a pair of metal foils, and a pair of outer leads. Each metal foil has one end welded to the filament and the other end welded to the outer lead. The metal foils are contained in glass sleeves and they are collectively inserted inside the bulb. The bulb is softened by heating and shrinks because its inside pressure is reduced to seal the metal foils therein. Since the amount of glass of each sealed portion is larger than the other portions of the bulb by the amount of the sleeve, the shape of the sealed portion is stabilized.

### TECHNICAL FIELD

The present invention relates to a heater lamp used for fixing a toner of a copy machine, a printer and the like, and more specifically it simplifies mounting of a heater lamp and realizes saving of the lamp mounting space.

### BACKGROUND ART

For the sealed portion of the halogen lamp used for fixing in a copy machine of JP-A 9-320547 (KOKAI) (Related art 1), it is considered to seal it by an evacuation method which prevents oxidization or breakage of a metal foil for sealing and does not need a chip tube used for sealing of gas or the like.

Since the related art 1 needs to decrease a thermal capacity to increase a lamp efficiency, its bulb has a thickness of about 1 mm. The bulb having such a thickness has disadvantages that when it is undergone the reduced-pressure sealing, the shrinkage of the bulb is not suppressed by the metal foil, a sealed portion becomes flat, a sealed shape is not stabilized, the center line of the sealed portion is largely displaced from the center line of the bulb, and the lamp cannot be attached in parallel.

Rod-shaped halogen lamps which are used for fixing in a toner fixing device of a copy machine or a printer of JP-A 10-106511 (KOKAI) (Related art 2) have outer leads externally extended to supply electric power in the longitudinal direction of a tubular heater through a pinch seal.

Since the related art 2 has the outer lead externally extended in the longitudinal direction of the halogen lamp, a predetermined space is required in the longitudinal direction of the tubular heater, such as a terminal member for mounting the halogen lamp and supplying electric power, so that downsizing of the halogen lamp attachment portion is limited.

The sealed portion of the halogen lamp used for fixing an image in a copy machine or the like of JP-A 2006-196258 (KOKAI) (Related art 3) is produced by sealing (pressure sealing) by a pinch seal. Since the sealing by the pinch seal causes a small thickness and a low strength because of its structure, there is used a method that a ceramic base is fixed to the sealing portion, and a heat-resistant base portion is supported and fixed by metal brackets.

In a case where the halogen lamp is used for the fixing roller, it is necessary to fix the halogen lamp to the roller with high dimensional accuracy and to determine a heat distribution of the coil of the halogen lamp and the arrangement of the roller with high dimensional accuracy in order to keep a uniform temperature of the fixing roller when fixing.

The related art 3 cannot provide high machining accuracy because the halogen lamp is made of glass. Therefore, it is necessary to use an adhesive agent such as cement interposed between the base portion and the sealing portion to make positioning, and it takes a lot of trouble in the work. It is also considered to have a structure that the bracket is used to hold a narrowed portion at the middle between the lamp bulb and the sealed portion, but there is a problem that the lamp cannot be easily positioned in the heat roller for fixing with high accuracy because of a problem of the machining accuracy of the sealed portion.

For the halogen lamp used for fixing in a copy machine of JP-A 2001-210454 (KOKAI) (Related art 4), it is considered to have a halogen lamp using a sealed portion by reduced-pressure sealing instead of the sealed portion produced by a pinch sealing method. Since the sealing by the pinch sealing results in a small thickness and weak strength in viewpoint of the structure, there is employed a mounting method by which a ceramic base is mounted on the sealed portion and the ceramic base portion is supported by metal clampers.

The related art 4 has disadvantages that the sealed portion has a shape larger than an outer diameter of the bulb, it is not determined to be perpendicular to the bulb, the sealed portion is bent, the right and left sealed portions are bent, the bulb at an exhaust pipe-connected portion is deformed and bent, and others. Therefore, the crossing of base members must be made large to cover it, and when ceramic cement or the like is used for fixing, bending occurs, the cement overflows, and the cement powder drops.

Patent Reference 1: JP-A 9-320547 (KOKAI)

Patent Reference 2: JP-A 10-106511 (KOKAI)

Patent Reference 3: JP-A 2006-196258 (KOKAI)

Patent Reference 4: JP-A 2001-210454 (KOKAI)

### DISCLOSURE OF THE INVENTION

The object of this invention is to suppress an influence of nonuniform shrinkage of a reduced-pressure sealed portion and save amounting space. And, mounting workability and downsizing of the mounting portion are realized by making it possible to position the halogen lamp with high accuracy by reduced-pressure sealing and to use the base member for power supply smaller than the sealed portion.

The halogen lamp of this invention comprises a tungsten filament inserted into a bulb made of heat-resistant glass, a pair of metal foils whose one ends are connected to both ends of the filament respectively and outer leads for electric power supply connected to the other ends of the individual metal foils with the bulb portions corresponding to the metal foils sealed by a reduced-pressure sealing method, wherein an amount of the glass at the portions corresponding to the metal foils is increased, and a cross section c1 of the bulb portion where the filament is housed and a glass cross section c2 of the portion where the metal foil is sealed by the bulb satisfy a relation of c1<c2.

The thermal capacity of the sealed portion sealed under reduced pressure while the thickness of the bulb is made thin is secured, so that a shrinkage at the time of reduced-pressure sealing can be suppressed, and the sealed portion can be suppressed from becoming flat. Thus, the sealed shape can be stabilized, the center line of the sealed portion is suppressed from displacing from that of the bulb, and a defect at the time of attaching the lamp can be prevented.

### BRIEF DESCRIPTION OF DRAWINGS

FIG. 1 is a configuration view illustrating a first embodiment of a halogen lamp of the present invention.

FIG. 2 is an enlarged view of the essential part of FIG. 1.

FIG. 3 is an explanatory view illustrating formation of a sealed portion.

FIG. 4 is an x-x′ sectional view of FIG. 3.

FIG. 5 is an explanatory view illustrating a conventional sealed portion and a sealed portion of the invention.

FIG. 6A to FIG. 6E are explanatory views illustrating an embodiment of the halogen lamp production method of the invention described with reference to FIG. 1.

FIG. 7A to FIG. 7E are explanatory views illustrating another embodiment of the halogen lamp production method of the invention described with reference to FIG. 1.

FIG. 8 is an explanatory view illustrating an effect of the halogen lamp of the invention.

FIG. 9 is an explanatory view illustrating an angle of a sealed portion and a lamp axis of the halogen lamp of the invention.

FIG. 10 is a configuration view illustrating a second embodiment of the halogen lamp of the invention.

FIG. 11 is a configuration view illustrating a third embodiment of the halogen lamp of the invention.

FIG. 12 is an enlarged view of the essential part of FIG. 1.

FIG. 13 is a left side view of FIG. 2.

FIG. 14 is a perspective view of FIG. 2.

FIG. 15A and FIG. 15B are perspective views illustrating a fourth embodiment of the halogen lamp of the invention.

FIG. 16 is a perspective view illustrating a first embodiment of a halogen lamp device of the invention.

FIG. 17 is a side view of FIG. 16.

FIG. 18 is a perspective view illustrating a second embodiment of the halogen lamp device of the invention.

FIG. 19 is a perspective view of the essential part of FIG. 18.

FIG. 20 is a configuration view illustrating a third embodiment of the halogen lamp device of the invention.

FIG. 21 is a perspective view of the essential part of FIG. 20.

FIG. 22 is a configuration view illustrating a modified embodiment of FIG. 20.

FIG. 23 is a configuration view illustrating a fourth embodiment of the halogen lamp device of the invention.

FIG. 24 is a configuration view showing an enlarged state of the left essential part of FIG. 23.

FIG. 25 is a configuration view showing an enlarged state of the right essential part of FIG. 23.

FIG. 26 is a right side view of FIG. 25.

FIG. 27 is a perspective view showing a state that FIG. 24 is attached to a stud.

FIG. 28 is a perspective view showing a state that FIG. 25 is attached to a stud.

FIG. 29A to FIG. 29E are explanatory views illustrating an embodiment of a production method of the halogen lamp of the invention described with reference to FIG. 11 to FIG. 14.

FIG. 30A to FIG. 30E is an explanatory view illustrating another embodiment of the production method of the halogen lamp described with reference to FIG. 23.

FIG. 31 is a front view illustrating a fifth embodiment of the halogen lamp of the invention.

FIG. 32 is a side view of FIG. 31.

FIG. 33 is a front view showing an essential part of FIG. 31 in an enlarged state.

FIG. 34 is a front view as viewed from a direction of arrow w of FIG. 33.

FIG. 35 is an x-x′ sectional view of FIG. 33.

FIG. 36 is a perspective view as viewed from a direction of arrow y on the right side of FIG. 33.

FIG. 37 is a sectional view illustrating an example of connection with an electric wire for feeding power to the halogen lamp of the invention.

FIG. 38 is a sectional view illustrating another example of connection with the electric wire for feeding power to the halogen lamp of the invention.

FIG. 39 is a sectional view showing a schematic structure illustrating an embodiment of a fixing device using the halogen lamp of the invention described with reference to FIG. 31.

FIG. 40 is a perspective view of an essential part of FIG. 39.

FIG. 41 is a z-z′ sectional view of FIG. 39.

FIG. 42 is a sectional view showing a schematic structure illustrating another embodiment of the fixing device using the halogen lamp of the invention described with reference to FIG. 31.

FIG. 43 is a sectional view illustrating a first modified embodiment of a positioning base of the halogen lamp of the invention described with reference to FIG. 31.

FIG. 44 is a sectional view illustrating a second modified embodiment of the positioning base of the halogen lamp of the invention described with reference to FIG. 31.

FIG. 45 is a sectional view illustrating a third modified embodiment of the positioning base of the halogen lamp of the invention described with reference to FIG. 31.

FIG. 46 is a sectional view illustrating a fourth modified embodiment of the positioning base of the halogen lamp of the invention described with reference to FIG. 31.

FIG. 47A and FIG. 47B are sectional views illustrating a fifth modified embodiment of the positioning base of the halogen lamp of the invention described with reference to FIG. 31.

FIG. 48A and FIG. 48B are sectional views illustrating a sixth modified embodiment of the positioning base of the halogen lamp of the invention described with reference to FIG. 31.

FIG. 49 is a configuration view illustrating a sixth embodiment of the heater lamp of the invention.

FIG. 50 is a configuration view illustrating the essential part of FIG. 49 in an enlarged state.

FIG. 51 is a perspective view illustrating the essential part of FIG. 49.

FIG. 52 is a perspective view illustrating the essential part of FIG. 49.

FIG. 53 is a configuration view illustrating a seventh embodiment of the heater lamp of the invention.

FIG. 54 is a configuration view illustrating the essential part of FIG. 53 in an enlarged state.

FIG. 55 is a perspective view illustrating the essential part of FIG. 53 in an enlarged state.

FIG. 56A to FIG. 56E are explanatory views illustrating an embodiment of a production method of the heater lamp of the invention described with reference to FIG. 49.

FIG. 57F and FIG. 57G are explanatory views illustrating an embodiment of the production method of the heater lamp of the invention described with reference to FIG. 49.

FIG. 58A to FIG. 58E are explanatory views illustrating an embodiment of the production method of the heater lamp of the invention described with reference to FIG. 53.

FIG. 59 is a schematic configuration view illustrating an embodiment of a fixing device using the heater lamp of the invention described with reference to FIG. 49.

FIG. 60 is a front view of a state of a portion of FIG. 59 as viewed from the left side to describe fitting of a tubular incandescent lamp.

FIG. 61 is a z-z′ sectional view of FIG. 59.

### EXPLANATION OF REFERENCE NUMERALS

100: Halogen lamp, 11: bulb, 12: filament, 121, 122: inner lead, 141, 142: sealed portion, 151, 152: metal foil, 161, 162: outer lead, 31, 32, 311, 71, 72: sleeve, 63, 64: burner, 200: heating device, 202: heating roller, 206: pressure roller

### BEST MODE FOR CARRYING OUT THE INVENTION

The best mode of carrying out the present invention will be described below in detail with reference to the drawings. In the accompanying drawings, like reference symbols refer to like or corresponding component parts.

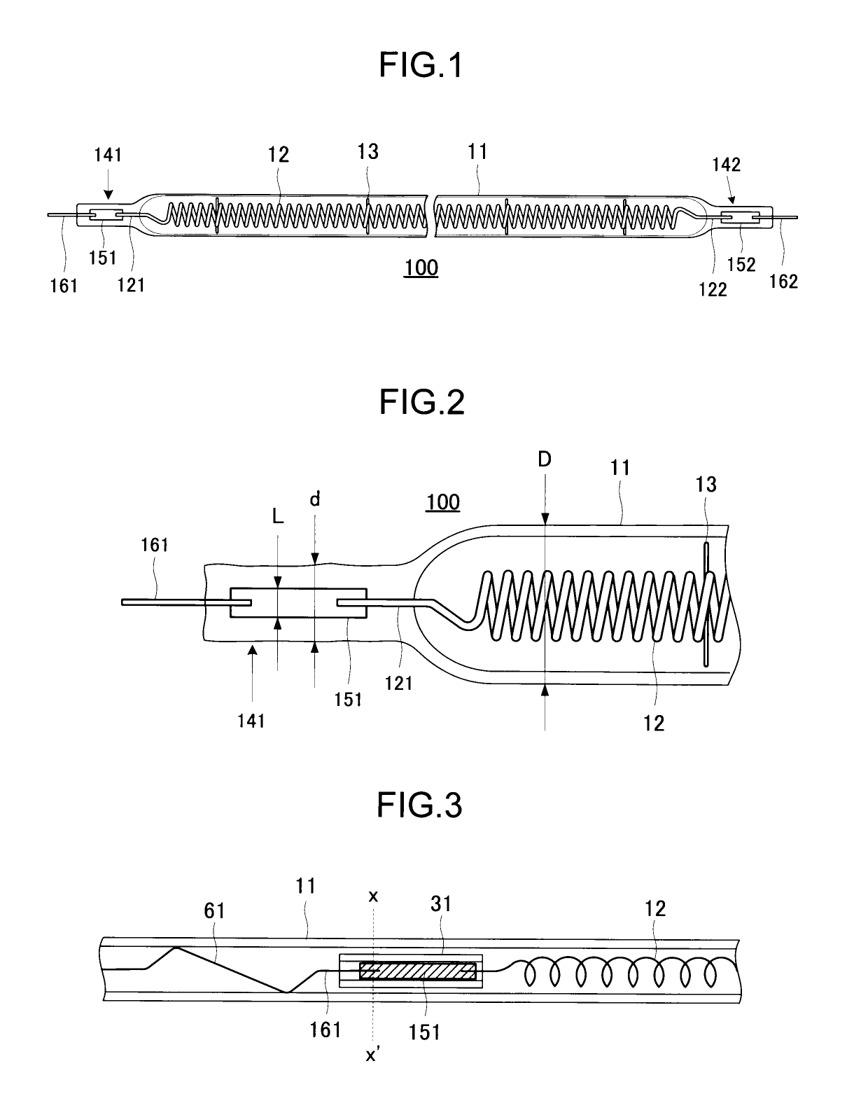

FIG. 1 is a configuration view, and FIG. 2 is an enlarged view of the essential part of FIG. 1 to illustrate a first embodiment of a halogen lamp of the present invention.

In FIG. 1, 100 is a halogen lamp which is a type of tubular incandescent lamp. For example, the halogen lamp 100 is often used as a heater for fixing and has a bulb 11 of quartz glass or the like having radioparency. A tungsten filament 12 which is an example of an electric resistance wire made of a refractory metal is housed concentrically as a heat source in the bulb 11. The filament 12 is held in a concentric state with respect to the bulb 11 by molybdenum anchors 13 which are arranged in plural in the axial direction within the bulb 11.

In the bulb 11, inert gas such as argon Ar or nitrogen N₂ is sealed under pressure of about 0.9×10⁵ Pa (Pascals) at normal temperature of 25° C. together with a mixture of a very small amount of halogen substances such as bromine Br and chlorine Cl. Both ends of the bulb 11 in its axial direction are provided with sealed portions 141, 142 by reduced-pressure sealing, respectively. Rectangular metal foils 151, 152 made of, for example, conductive molybdenum (Mo) having a similar expansion coefficient as the bulb 11 are buried in the sealed portions 141, 142, respectively.

One end of an inner lead 121 whose other end is connected to the filament 12 is connected to one end of the metal foil 151, and one end of an inner lead 122 whose other end is connected to the filament 12 is connected to one end of the metal foil 152. The other end of the metal foil 151 is connected to an outer lead 161 for supplying electric power, and the other end of the metal foil 152 is connected to an outer lead 162 for supplying electric power.

The reduced-pressure sealing seals temporarily the lamp at portions other than the sealing portion and airtightly seals the molybdenum foil with the lamp interior including the sealing portion under reduced pressure. This sealing method can improve the strength of the sealed portion because the quartz glass thickness is not deviated as in a case of the sealing method based on pinch sealing.

Relations among the outer diameters of the sealed portions 141, 142 undergone the reduced-pressure sealing, the outer diameter of the bulb 11 and the widths of the metal foils 151, 152 are described with reference to FIG. 2. FIG. 2 shows the sealed portion 141 and the bulb 11 partly in an enlarged state. The sealed portion 142 side is also formed to have the same structure.

In FIG. 2, it is determined that an outer diameter of the sealed portion 141 is d, an outer diameter of the bulb 11 is D and widths of the metal foils 151, 152 are L. Then, the outer diameter d of the sealed portion 141 is determined to have a size satisfying a condition of 1.4 L<d<D.

When the above condition is satisfied, even if the bulb 11 has a small thickness, it can be prevented that the sealed portions 141, 142 undergone the reduced-pressure sealing are displaced from the center line of the bulb 11 or the sealed portion becomes flat.

Formation of the sealed portion 141 having the outer diameter d of the above-described condition of 1.4 L<d<D is described with reference to FIG. 3 to FIG. 5.

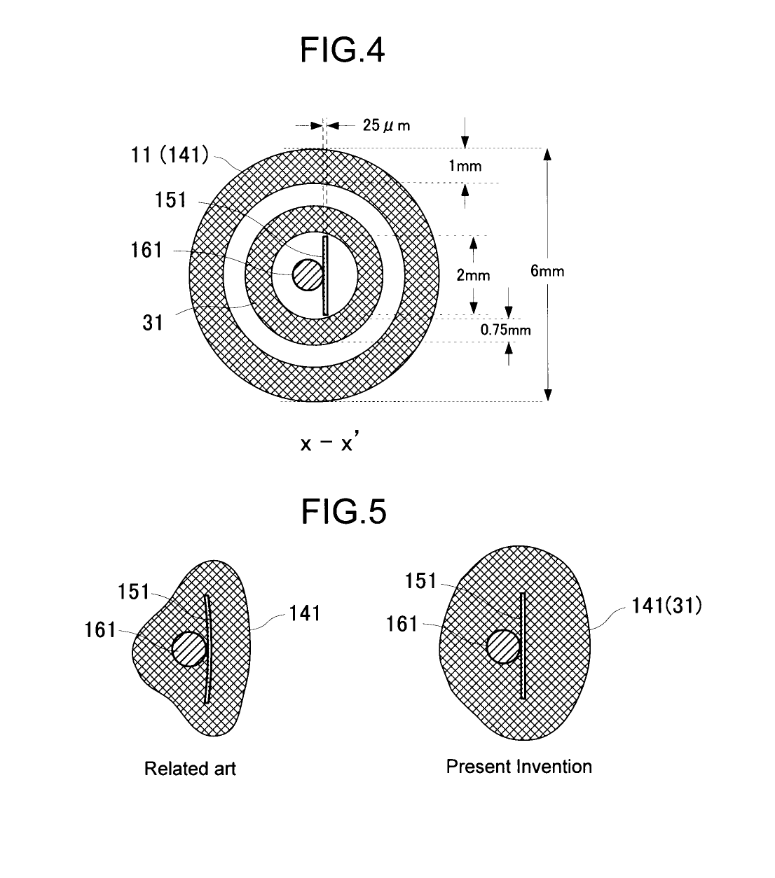

Before the sealed portion 141 is formed within the bulb 11, the metal foil 151 is housed in a sleeve 31 which is made of the same material as the bulb 11 as shown in FIG. 3. This state is shown in FIG. 4 which is an x-x′ sectional view of FIG. 3. The sleeve 31 has a thickness of about 0.75 mm.

The bulb 11 and the sleeve 31 in the above state are melted, so that the sealed portion 141 having a large glass cross section of the invention can be formed as shown on the right side of FIG. 5 in comparison with the cross section of a conventional sealed portion shown on the left side of FIG. 5. It can be said that the relation of a cross section c1 of the bulb 11 and a glass cross section c2 of the sealed portion having the sleeve 31 additionally melted is determined to be c1<c2. A large glass cross section of the sealed portion means that a thermal capacity is large, and a defect due to the conventional reduced-pressure sealing with a small thermal capacity can be resolved.

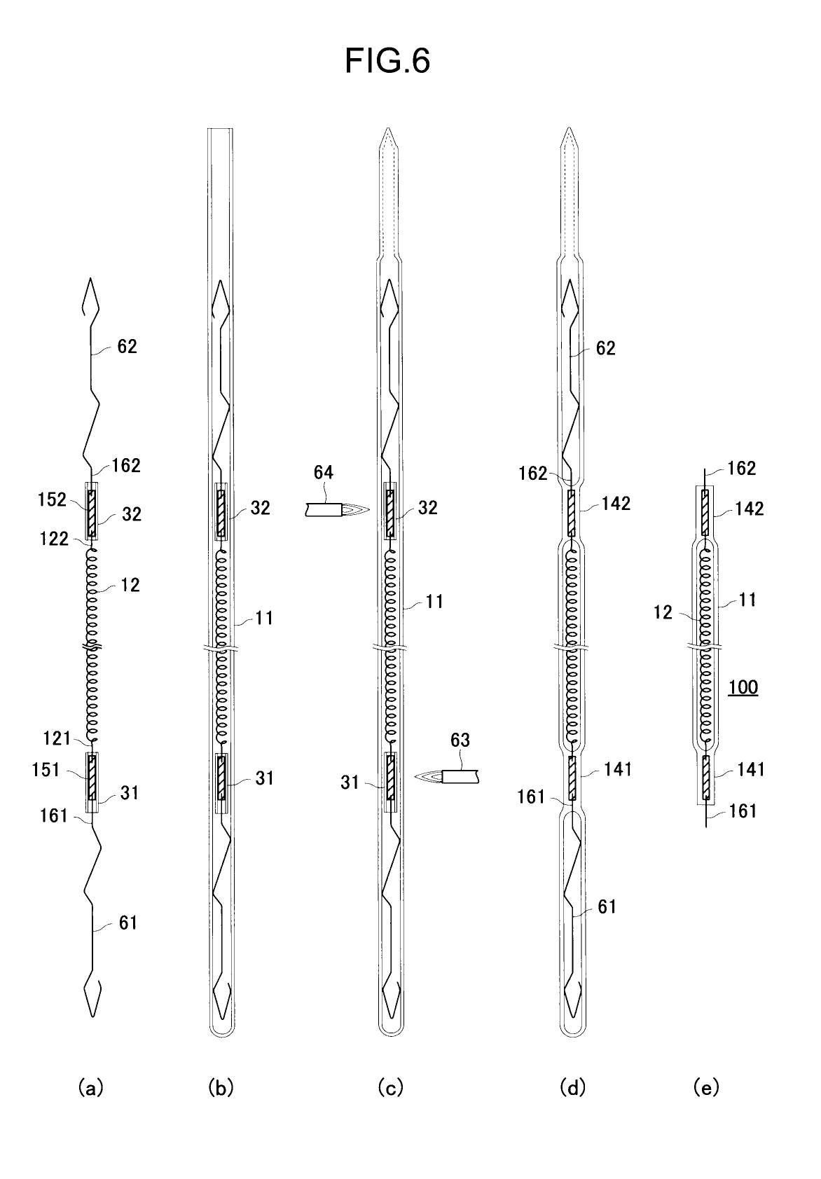

One embodiment of the halogen lamp production method described with reference to FIG. 1 is described with reference to FIG. 6A to FIG. 6E.

First, FIG. 6A shows that both ends of the filament 12 are connected to the inner leads 121, 122, which are connected to the metal foils 151, 152, which are connected to the outer leads 161, 162, whose tip ends are integrally connected to anchors 61, 62 in series. The metal foils 151, 152 are inserted into the sleeves 31, 32. The connection points among the filament 12, the inner lead 121, the metal foil 151 and the outer lead 161 which are serially connected and the connection points among the filament 12, the inner lead 122, the metal foil 152 and the outer lead 162 which are serially connected are connected by, for example, spot welding, respectively.

In FIG. 6B, the filament 12 and others integrated by connecting in series in FIG. 6A are housed in the bulb 11 which is made of, for example, quartz glass with one end sealed in advance. The filament 12 and others which are connected in series by the anchors 61, 62 are arranged in series within the bulb 11.

In FIG. 6C, 500 torr of halogen gas is sealed, temporary exhaustion is performed, and the open end side of the bulb 11 is undergone reduced-pressure sealing. And, portions which become the sealed portions 141, 142 are fired with predetermined thermal power of burners 63, 64, and the bulb is rotated at a predetermined rotation speed to form the sealed portions 141, 142 having a thickness with the sleeves 31, 32 added.

In FIG. 6D, both open sides of the bulb are cut off by means of, for example, a laser or the like to remain the sealed portions 141, 142, and the anchors 61, 62 and the outer leads 161, 162 are also cut off to have an appropriate length. Thus, the halogen lamp 100 of FIG. 6E is completed.

According to this halogen lamp production method, the halogen lamp which has an outer diameter of the sealed portion based on the thickness of the sleeve in the above-described condition of 1.4 L<d<D can be realized.

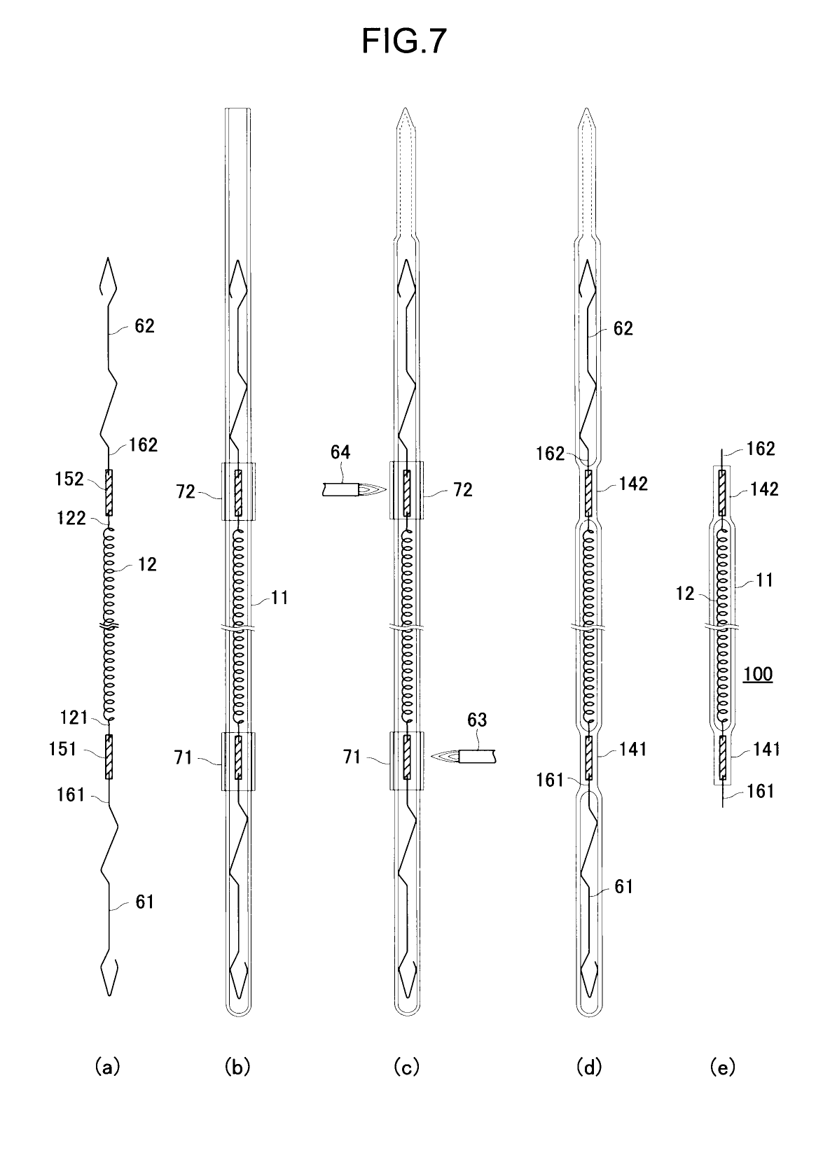

FIG. 7A to FIG. 7E are explanatory views illustrating another embodiment of the halogen lamp production method described with reference to FIG. 1. This embodiment forms the sealed portion which is integrated with the bulb to have a desired outer diameter by inserting the sleeve to cover the outer circumferential surface of the bulb of the sealed portion and firing by burners.

FIG. 7A shows that both ends of the filament 12 are connected to the inner leads 121, 122, which are connected to the metal foils 151, 152, which are connected to the outer leads 161, 162, whose tip ends are integrally connected to the anchors 61, 62 in series. The connection points among the filament 12, the inner lead 121, the metal foil 151 and the outer lead 161 which are serially connected and the connection points among the filament 12, the inner lead 122, the metal foil 152 and the outer lead 162 which are serially connected are connected by, for example, spot welding, respectively.

In FIG. 7B, the filament 12 and others which are integrally formed by connecting in series in FIG. 7A are housed into, for example, the quartz glass bulb 11 whose one end is sealed in advance. In addition, sleeves 71, 72 are arranged to position at the outer circumferential surface of the bulb 11 in which the metal foils 151, 152 are arranged. The filament 12 and others which are arranged in series are kept in a state arranged in series within the bulb 11 by the anchors 61, 62.

In FIG. 7C, 500 torr of halogen gas is sealed, temporary exhaustion is performed, and the open end side of the bulb 11 is undergone reduced-pressure sealing. And, portions including the sleeves 71, 72 and the bulb 11 which become the sealed portions 141, 142 are fired with predetermined thermal power of the burners 63, 64, and the bulb 11 is rotated at a predetermined rotation speed to form the sealed portions 141, 142 having a thickness with the sleeves 31, 32 added.

In FIG. 7D, both open sides of the bulb 11 are cut off by means of, for example, a laser or the like to remain the sealed portions 141, 142, and the anchors 61, 62 and the outer leads 161, 162 are also cut off to have an appropriate length. Thus, the halogen lamp 100 of FIG. 7E is achieved.

By this halogen lamp production method, a halogen lamp having an outer diameter of the sealed portion in the above-described condition of 1.4 L<d<D can be realized on the basis of the thickness of the sleeve.

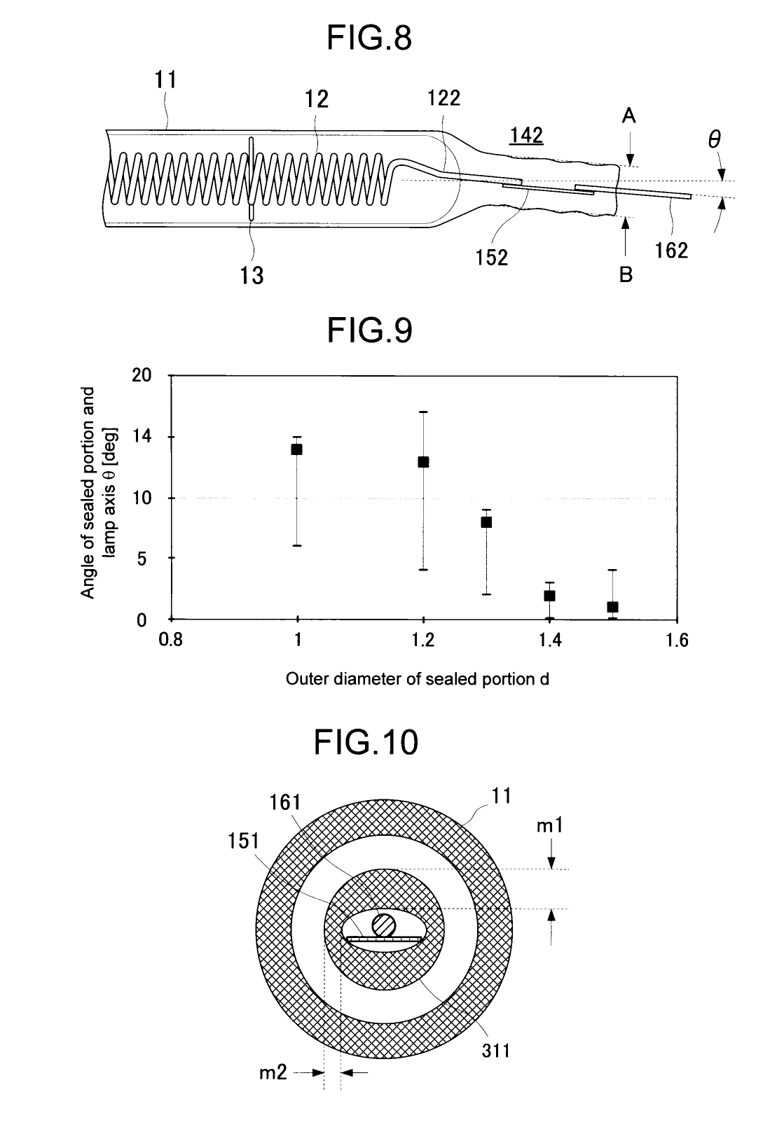

Referring to FIG. 8 and FIG. 9, an embodiment that the halogen lamp completed by the above-described method can remedy a defect due to reduced-pressure sealing is described. The halogen lamp 100 was determined to have specifications as also shown in FIG. 4 that quartz glass was used for the bulb 11, which had an outer diameter of 6 mm and a thickness of 1 mm, and molybdenum was used for the metal foils 151, 152, which had a length of 6 mm, a width of 2 mm and a thickness of 25 μm.

In the process of FIG. 7C, the bulb 11 was fired with predetermined thermal power of the burners 61, 62 and rotated at a predetermined rotation speed to seal it. When the diameters d of the sealed portions 141, 142 are small and the sealed portions 141, 142 have a flat cross section, both surfaces of the sealed portions 141, 142 become irregular and the central axis becomes obscure, both of side A and side B shown in FIG. 8 are measured for their inclination, and their average was determined to be inclination θ.

Consequently, it is seen as shown in FIG. 9 that when the outer diameters d of the sealed portions 141, 142 with respect to widths L of the metal foils 151, 512 are larger than 1.4 L, a higher degree of parallelism can be obtained between the bulb 11 and the sealed portions 141, 142. And, the upper limit of the outer diameter d of the sealed portions 141, 142 and the size allowing the insertion of the sleeves 31, 32 are an outer diameter D of the bulb 11 and the widths L of the metal foils 151, 152.

Substantially the same effects can be obtained even when the bulb 11 is fixed and the burners 63, 64 are moved around the bulb 11.

In the first embodiment of the above-described halogen lamp, the thermal capacity of the sealed portion sealed under reduced pressure is secured while the thickness of the bulb is made thin, so that a shrinkage at the time of reduced-pressure sealing can be suppressed, and the sealed portion can be suppressed from becoming flat. Thus, the sealed shape can be stabilized, the center line of the sealed portion is suppressed from displacing from that of the bulb, and a defect at the time of attaching the lamp can be prevented.

FIG. 10 is a sectional view of the portion corresponding to FIG. 4 and used to describe another embodiment of the halogen lamp of the invention. For description, like component parts corresponding to those of the above-described embodiment are denoted by like reference numerals. The sealed portion 141 side is shown here, but the sealed portion 142 side is also configured in the same way.

In this embodiment, it is determined that a relation between thickness m1 of a sleeve 311 in the thickness direction of the metal foil 151 to thickness m2 of the sleeve 311 in the width direction is m1>>m2. Thus, the cross section of the sealed portion 141, which tends to have a large outer diameter in the breadth direction of the metal foil 151 due to the influence of the metal foil 151, can be made to have a shape closer to a circle.

In this embodiment, the sealed shape can be stabilized, the center line of the sealed portion can be suppressed from displacing from that of the bulb, and the sealed portion can be made to have a shape closer to a circle with irregularity further decreased. Thus, mounting accuracy can be improved.

The sleeve 311 which is arranged within the bulb 11 was described above, but the same effect is also provided when it is arranged on the outside surface of the bulb positioned at the metal foil and when the thickness at the position opposed to the sealed portion is increased.

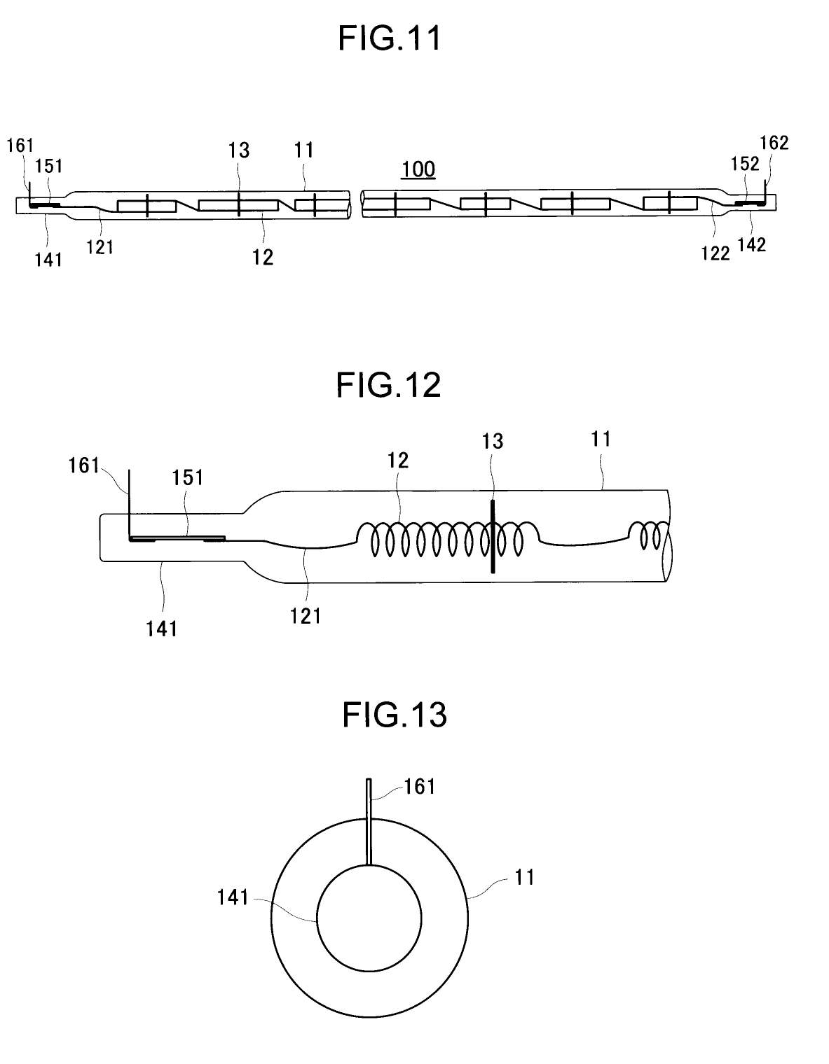

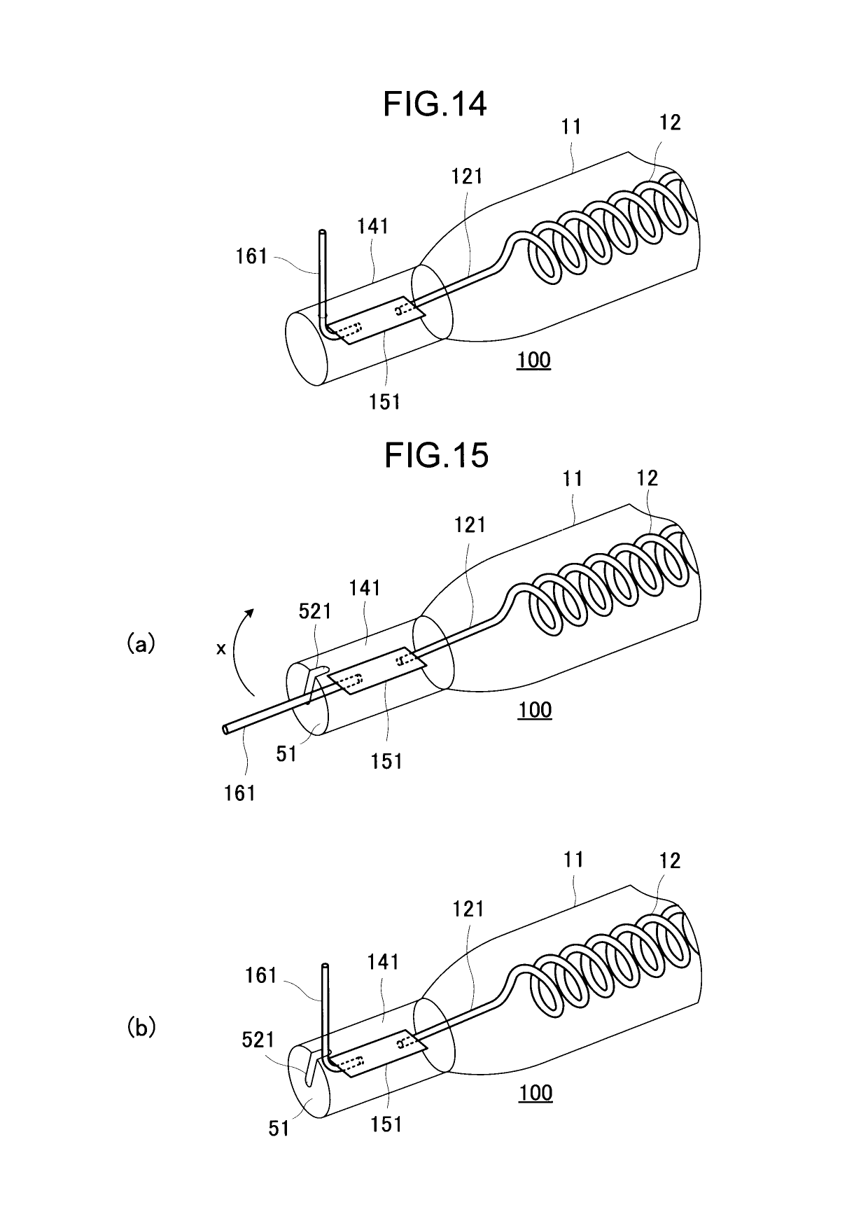

FIG. 11 through FIG. 14 are used to describe a third embodiment of the halogen lamp of the invention. FIG. 11 is a configuration view, FIG. 12 is a configuration view illustrating the essential part of FIG. 11 in an enlarged state, FIG. 13 is a left side view of FIG. 12, and FIG. 14 is a perspective view of FIG. 12.

In FIG. 11 and FIG. 12, 100 is a halogen lamp which is a type of tubular incandescent lamp. For example, the halogen lamp 100 is often used as a heater for fixing and has a bulb 11 of quartz glass or the like having radioparency. A tungsten filament 12 which is an example of an electric resistance wire made of a refractory metal is housed concentrically as a heat source in the bulb 11. The filament 12 is provided with a loosely wound or straight skipped part between a plurality of coil-shaped portions formed by winding a tungsten wire and an inner lead 121 at both ends and held in a concentric state with respect to the bulb 11 by anchors 13 which are arranged in plural in the axial direction within the bulb 11. A required amount of halogen gas is included together with inert gas such as argon within the bulb 11, and sealed portions 141, 142 are formed by sealing in the axial direction by reduced-pressure sealing (shrink sealing). Rectangular metal foils 151, 152 made of, for example, conductive molybdenum (Mo) having a similar expansion coefficient as the bulb 11 are buried in the sealed portions 141, 142, respectively.

In the bulb 11, the inert gas such as argon Ar or nitrogen N₂ is sealed under pressure of about 0.9×10⁵ Pa (Pascal) at normal temperature of 25° C. together with a mixture of a very small amount of halogen substances such as bromine Br and chlorine Cl.

The reduced-pressure sealing seals temporarily the lamp at portions other than the sealing portions and airtightly seals the molybdenum foil with the lamp interior including the sealing portions under reduced pressure. This sealing method improves the strength of the sealed portions because the quartz glass thickness is not deviated as in a case of the sealing method based on pinch sealing.

One end of the metal foil 151 is connected to an internal lead 121 at one end of the filament 12, and one end of the metal foil 152 is connected to an internal lead 122 at the other end of the filament 12. The other end of the metal foil 151 is connected to an outer lead 161 for supplying electric power, and the other end of the metal foil 152 is connected to an outer lead 162 for supplying electric power.

As shown in FIG. 13 and FIG. 14, the outer leads 161, 162 are externally extended from the outer circumferential surfaces of the sealed portions 141, 142, respectively. As also shown in FIG. 12, the outer leads 161, 162 are routed to externally extend from the sides opposite to the sides connected to the metal foils 151, 152, thereby preventing the connected portions between the outer leads 161, 162 and the metal foils 151, 152 from being broken.

Thus, the outer lead 161 is not extended from the extended lines of the sealed portions 141, 142 but extended from the outer circumferential surfaces of the sealed portions. Therefore, an electric power supply wire and the like can be routed from the direction orthogonal to the longitudinal direction of the lamp, and it can contribute to saving of a space for mounting the lamp.

FIG. 15A and FIG. 15B are perspective views illustrating a fourth embodiment of the halogen lamp of the invention. FIG. 15 A and FIG. 15B correspond to FIG. 14, and like component parts are denoted by like reference numerals. FIG. 15A and FIG. 15B show only one of the sealed portions but the other sealed portion also has the same structure.

As shown in FIG. 15A, a recess portion 521 is formed to extend from an open end 51 of the sealed portion 141 to the outer lead 161 being closer to the bulb 11. The outer lead 161 extended along the axis of the sealed portion 141 is bend along the recess portion 521 in the direction indicated by arrow x in the drawing.

As shown in FIG. 15B, the outer lead 161 is shaped to extend in a direction orthogonal to the outer circumferential surface of the sealed portion 141.

In this embodiment, the outer lead 161 is also extended from the outer circumferential surface of the sealed portion 141, and an electric power supply wire or the like can be routed from a direction orthogonal to the longitudinal direction of the lamp. Therefore, it becomes possible to save a space for mounting the lamp.

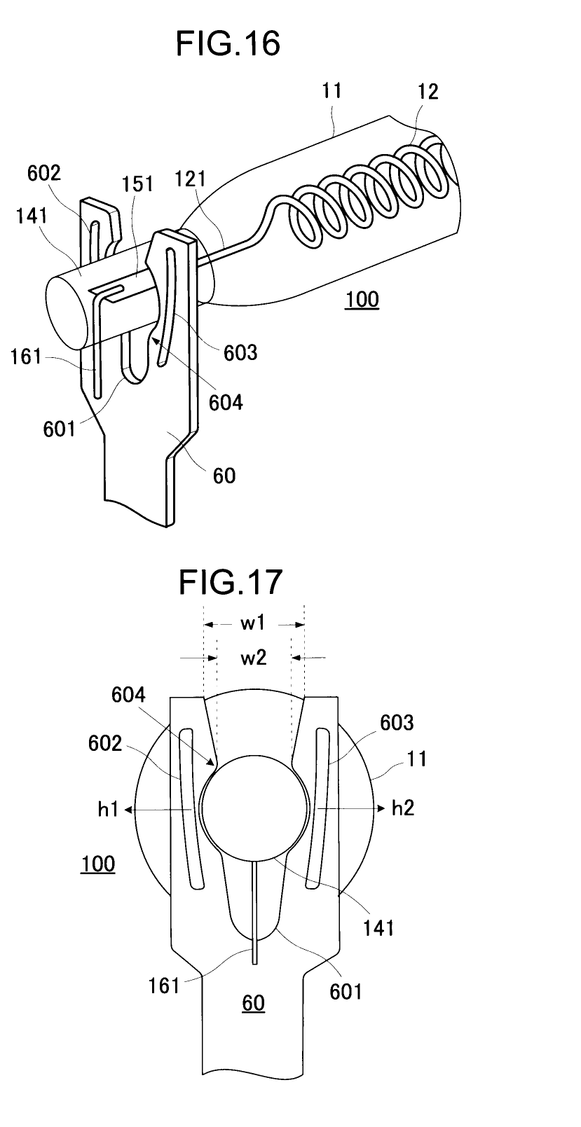

FIG. 16 and FIG. 17 are used to describe a first embodiment of the halogen lamp device of the invention. FIG. 16 is a perspective view and FIG. 17 is a side view of FIG. 16. FIG. 16 shows a perspective view of the halogen lamp 100 corresponding to the above-described FIG. 12. For description, like component parts are denoted by like reference numerals.

In FIG. 16, 60 denotes a bracket whose one end is fixed as a support means to an unshown chassis or the like. The other end of the bracket 60 catches the sealed portion 141 of the halogen lamp 100. The bracket 60 is made of, for example, a conductive metal plate and configured to supply electric power directly.

The bracket 60 is provided with a cutout 601 in its tip end as also shown in FIG. 17 and also provided with slits 602, 603 with the cutout 601 and a predetermined space between them. The entrance of the cutout 601 has a width w1, which is larger than an outer diameter of the sealed portion 141 and becomes smaller gradually. A holding portion 604 which is slightly smaller than the diameter of the sealed portion 141 is formed on the opposed side surfaces at the middle of the cutout 601. The entrance of the holding portion 604 has a width w2 which is smaller than the outer diameter of the sealed portion 141.

When the sealed portion 141 is inserted into the cutout 601, the sealed portion 141 hits both inner surfaces of the cutout 601 in front of the holding portion 604 which is smaller than its diameter. When the sealed portion 141 is further pushed against it deep into the cutout 601, the inner surfaces of the cutout 601 are pushed in directions of arrows h1, h2 toward the slits 602, 603, and the sealed portion 141 is held by the holding portion 604. After the sealed portion 141 has passed through the both side surfaces of the cutout 601 which is smaller than the sealed portion 141, the sealed portion 141 is surely held by an action of returning to the original shape.

To supply electric power, a lead wire is directly connected to the outer lead 161 by welding or the like, or a connection tool such as an unshown connector or the like is used. Thus, the halogen lamp 100 can be heated. The sealed portion 142 is also configured in the same manner and supported by a bracket.

In this embodiment, since the outer lead for supplying electric power can be connected at a position closer to the bulb than to the open end of the sealed portion, the space required in the longitudinal direction of the halogen lamp can be reduced. This holding means is also effective for the halogen lamp configured as shown in FIG. 1, which does not extend the outer lead from the outer circumferential surface.

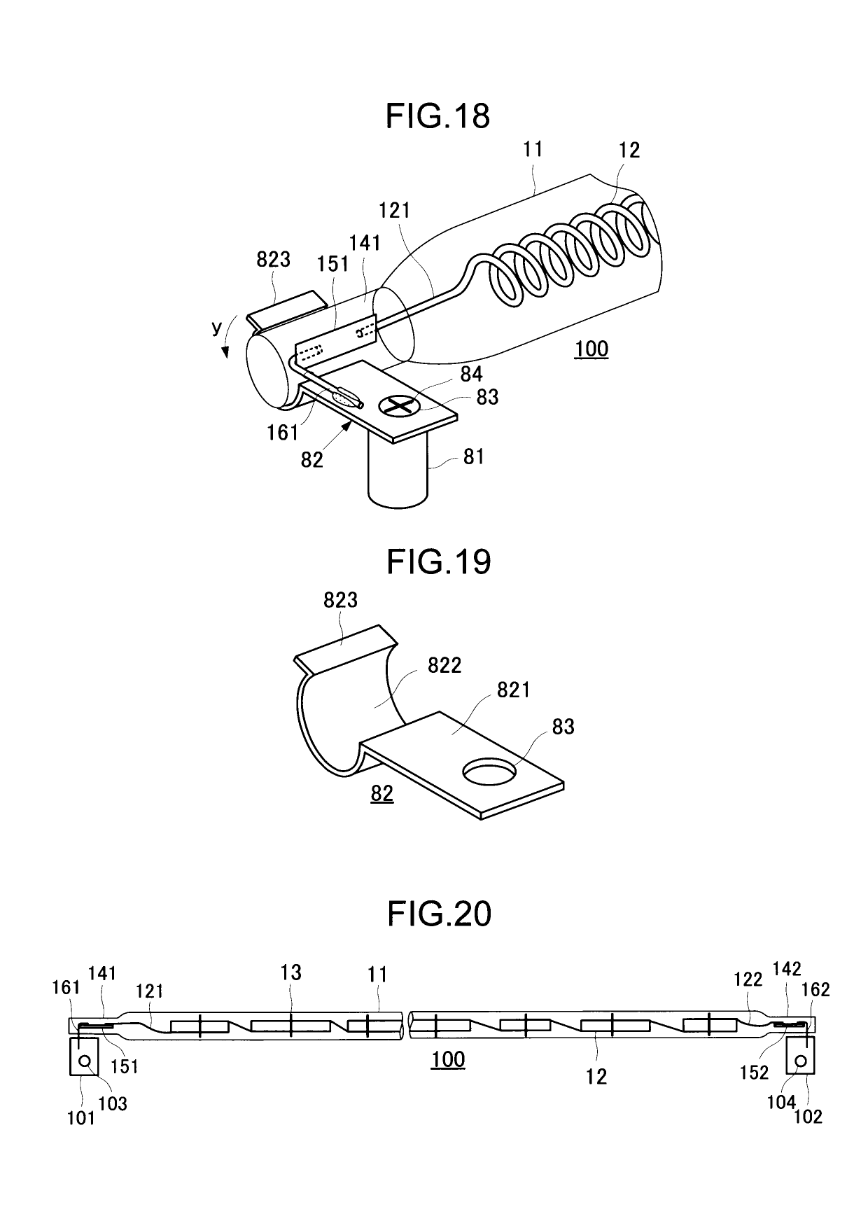

FIG. 18 and FIG. 19 are used to describe a second embodiment of the halogen lamp device of the invention. FIG. 18 is a perspective view and FIG. 19 is a perspective view of the essential part of FIG. 18. FIG. 19 shows a perspective view of the halogen lamp 100 corresponding to FIG. 12. For description, like component parts are denoted by like reference numerals.

In FIG. 18, 81 denotes a stud as a support means whose one end is integrally formed with, for example, an unshown frame. A holding member 82 is fixed to the other end of the stud 81 by screwing a screw 84 into a mounting hole 83.

As shown in FIG. 19, the holding member 82 is made of, for example, stainless steel and comprised of a support portion 821 in which the mounting hole 83 is formed, a curved holding portion 822 for holding the sealed portion 141 of the halogen lamp 100 and an operating portion 823 for opening the holding portion 822.

If the frame is made of a resin, the stud 81 can connect an unshown electric power supply wire at the time of supporting the holding member 82 with the screw 84. If the stud 81 is metal, the stud 81 itself is insulated or insulation is provided between the holding member 82 and the stud 81. Thus, when worked to secure with the screw 84, it becomes possible to electrically connect between the holding member 82 and the electric power supply wire.

The operating portion 823 is operated in the direction of arrow y in the drawing to expand the inlet of the holding portion 822 so as to push the sealed portion 141 into the holding member 82 fixed with the screw to the stud 81. When the operation of the operating portion 823 is terminated after the insertion, the sealed portion 141 is surely held when the holding portion 822 having resiliency returns to the original state. At this time, the outer circumferential surface of the sealed portion 141 causes the externally extended outer lead 161 to contact the support portion 821, and in this state, the outer lead 161 and the support portion 821 are electrically connected by welding.

In this embodiment, the halogen lamp is fitted to the holding member, which is previously attached to the stud, by a single action. Thus, the outer lead and the holding member can be connected. Therefore, workability becomes good. In this case, the holding member and the outer lead can be attached at a position closer to the bulb than to the open end of the sealed portion. Thus, it contributes to downsizing of the system.

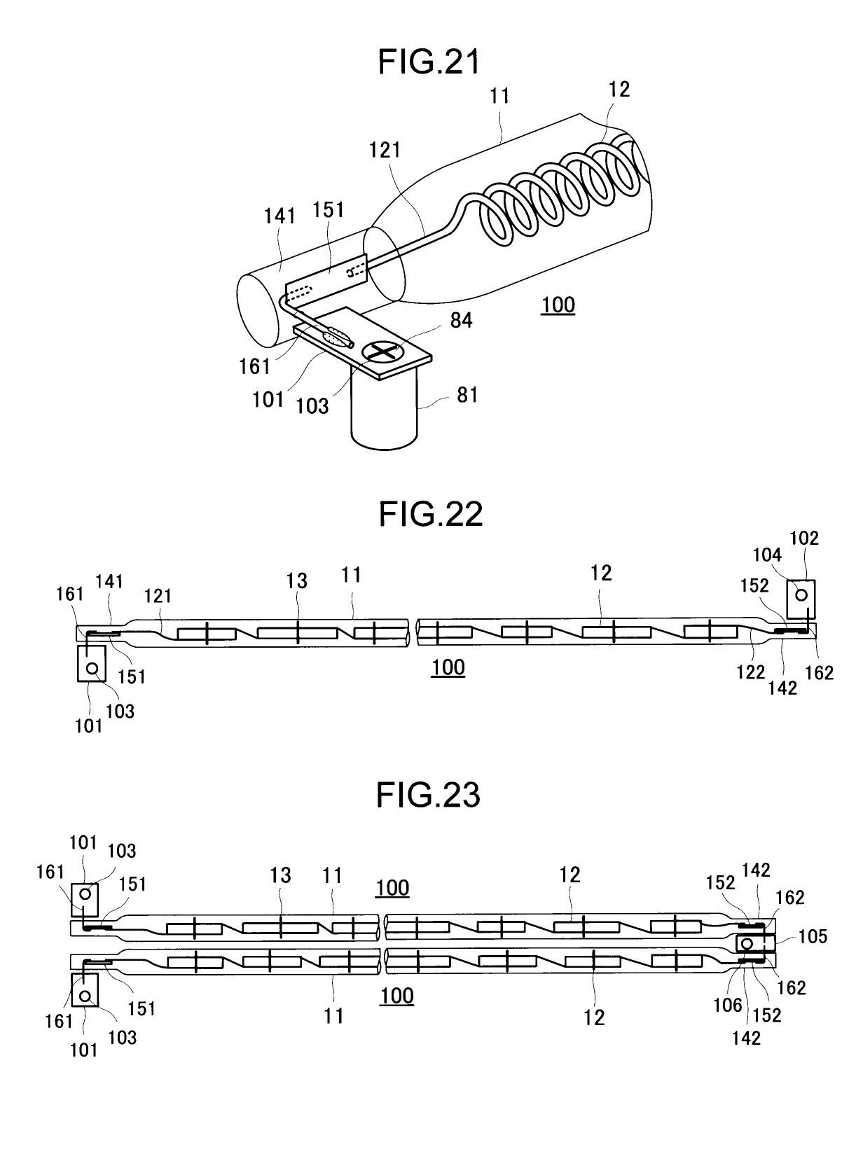

FIG. 20 and FIG. 21 are used to describe a third embodiment of the halogen lamp device of the invention. FIG. 20 is a configuration view and FIG. 21 is a perspective view of the essential part of FIG. 20. FIG. 21 shows a perspective view of the halogen lamp 100 corresponding to FIG. 12. For description, like component parts are denoted by like reference numerals.

In this embodiment, a conductive fitting 101 to supply electric power to the outer lead 161 of the above-described halogen lamp 100 and a fitting 102 to the outer lead 162 are connected by welding on the extended lines of the outer leads 161, 162. Mounting holes 103, 104 are formed in the fittings 101, 102, respectively.

As shown in FIG. 21, the fitting 101 is fixed to the stud 81 with the screw 84 in the same manner as in FIG. 18.

In this case, the halogen lamp 100 can be attached by a simple work to fix the fitting 101, which is previously connected to the outer lead 161, to the stud 81 with the screw 84. And, attachment of the fitting 101 to which the outer lead 161 is adhered can also be effected on the side of the bulb 11.

FIG. 22 is a configuration view illustrating a modified embodiment of FIG. 20. In this embodiment, the outer leads 161, 162 are extended in opposite directions from the outer circumferential surfaces of the right and left sealed portions 141, 142.

In this case, when the fittings 101, 102 are attached to the studs 81 attached to an unshown chassis or the like, the halogen lamp 100 which is supported at two points can be attached in a good right and left balance.

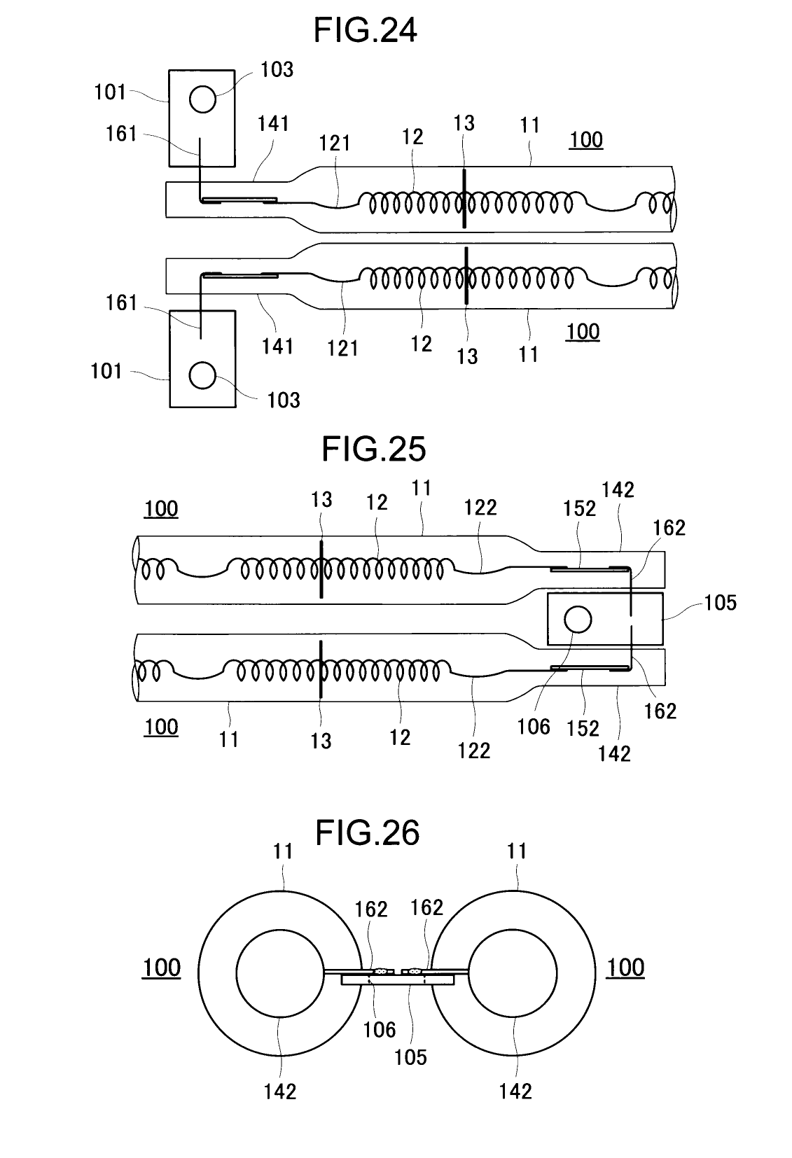

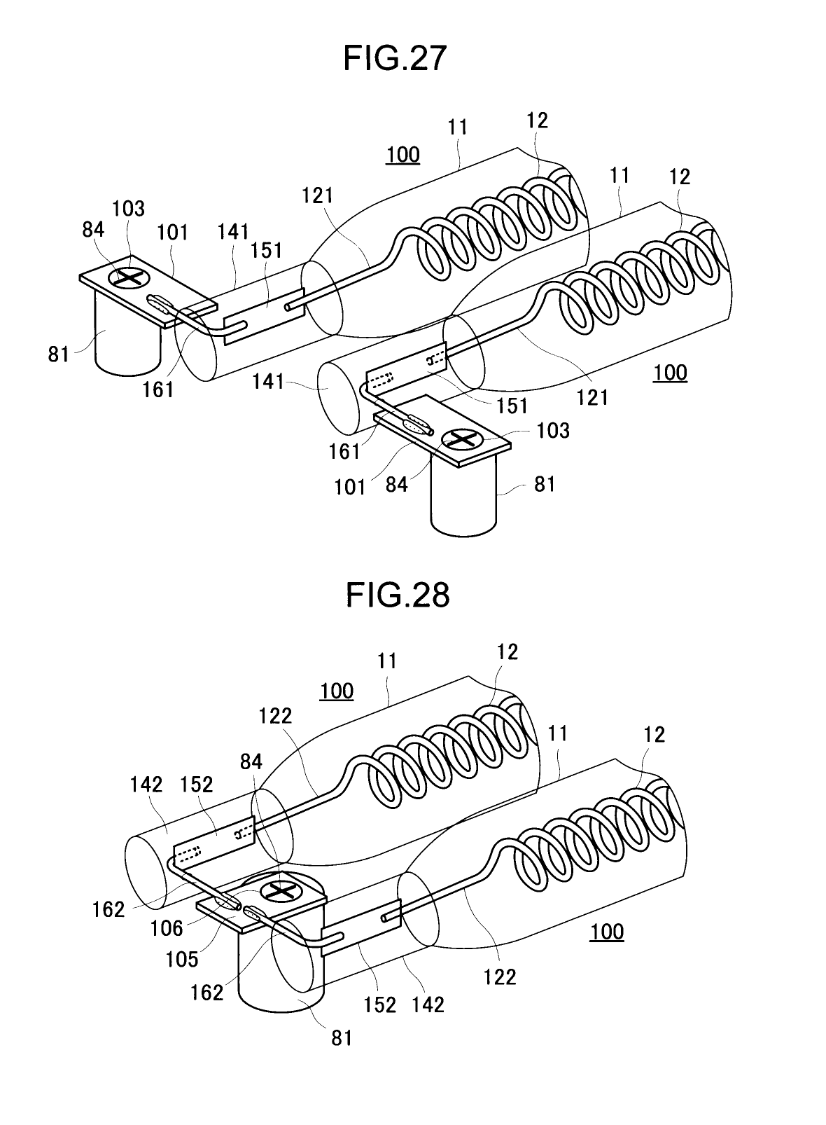

FIG. 23 through FIG. 28 are used to describe a fourth embodiment of the halogen lamp device of the invention. FIG. 23 is a configuration view, FIG. 24 is a configuration view of the left essential part of FIG. 23 in an enlarged state, FIG. 25 is a configuration view of the right essential part of FIG. 23 in an enlarged state, FIG. 26 is a right side view of FIG. 25, FIG. 27 is a perspective view of FIG. 24 attached to the stud, and FIG. 28 is a perspective view of FIG. 25 attached to the stud. For description, like component parts corresponding to those of the above embodiment are denoted by like reference numerals.

This embodiment is an example of attaching plural halogen lamps 100. As shown in FIG. 24, the outer leads 161 of two halogen lamps 100 are directed in opposite directions and connected to the fittings 101. As shown in FIG. 25, the outer leads 162 are directed in the same direction and connected by, for example, welding to a common fitting 105 in which the mounting hole 106 is formed as shown in FIG. 26. The common fitting 105 may be different metal fittings.

FIG. 27 shows a state that the outer leads 161 of the halogen lamps 100 having the fittings 101 directed in the opposite directions are fixed to the studs 81 which are fixed to an unshown chassis with the screw 84 in the same manner as in FIG. 18.

FIG. 28 shows a state that the other outer leads 162 of the halogen lamps 100 having the common fitting 105 directed in the same direction are fixed to the studs 81 which are fixed to an unshown chassis or the like with the screw 84 in the same manner as in FIG. 18.

Thus, it becomes possible to support the halogen lamps 100 by simply fixing the fittings 101, 105, which are previously connected to the outer leads 161, 162 externally extended from the outer circumferential surfaces of the sealed portions 141, 142 of the halogen lamps 100, to the support means such as the studs fixed to the chassis or the like. It is also possible to configure such that an electric power supply wire is electrically connected when the screws 84 are tightened, and the halogen lamps 100 can be attached on the side of the bulbs 11. This holding means is also effective for the halogen lamp of FIG. 1 which has the outer leads bent at the ends of the sealed portions.

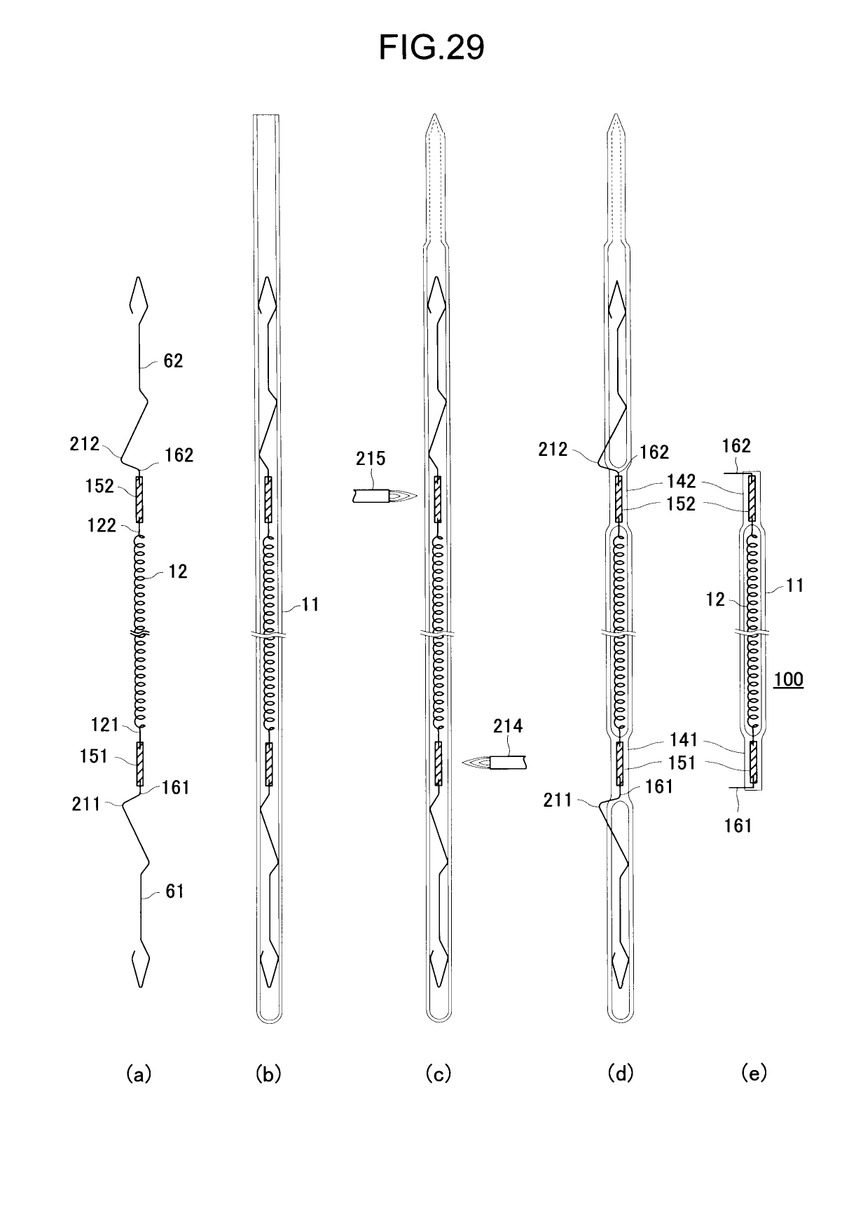

FIG. 29A to FIG. 29E are explanatory views illustrating an embodiment of the halogen lamp production method of the invention described with reference to FIG. 11 to FIG. 14.

In FIG. 29A, the inner leads 121, 122, the metal foils 151, 152 and the outer leads 161, 162 are sequentially connected in series to both ends of the filament 12, respectively. The connection points among one end of the filament 12, the inner lead 121, the metal foil 151 and the outer lead 161 which are serially connected and the connection points among the other end of the filament 12, the inner lead 122, the metal foil 152 and the outer lead 162 which are serially connected are connected by, for example, spot welding, respectively. The outer leads 161, 162 are integrally provided with largely bent portions 211, 212 which deviate from the axis line of the inner lead 122 near the metal foils 151, 152.

In FIG. 29B, the integrated filament 12 and others connected in series in FIG. 29A are housed against the bending elasticity of the bent portions 211, 212 and others in the bulb 11 with its lower end sealed in the drawing. The integrated filament 12 and others can hold the state of FIG. 29B in the bulb 11 by the elasticity of the bent portions 211, 212.

In FIG. 29C, a portion of the bulb 11 where the metal foil 151 is positioned is externally melted by a burner 214 using gas to integrate the portion of the bulb 11 and the metal foil 151 by the action of its own weight below the point where the burner 214 is fired to form the sealed portion 141.

Similarly, a portion of the bulb 11 where the metal foil 152 is positioned is externally melted by a burner 215 using gas to integrate the portion of the bulb 11 and the metal foil 152 by the action of its own weight below the point where the burner 215 is fired to form the sealed portion 142.

The processes of forming the sealed portions 141, 142 may be performed separately but they can also be configured at the same time. Simultaneous configuration can contribute to improvement of productivity.

At this time, the bent portions 211, 212 are partly protruded externally from the bulb 11 as shown in FIG. 29D.

In FIG. 29D, both open sides of the bulb 11 are cut off by means of, for example, a laser or the like to remain the sealed portions 141, 142, and the outer leads 161, 162 are also cut off to have an appropriate length. The outer leads 161,162 are bent to protrude from the outer circumferential surfaces of the sealed portions 141, 142. Thus, the outer leads 161, 162 protruded from the outer circumferential surfaces shown in FIG. 29E can be realized.

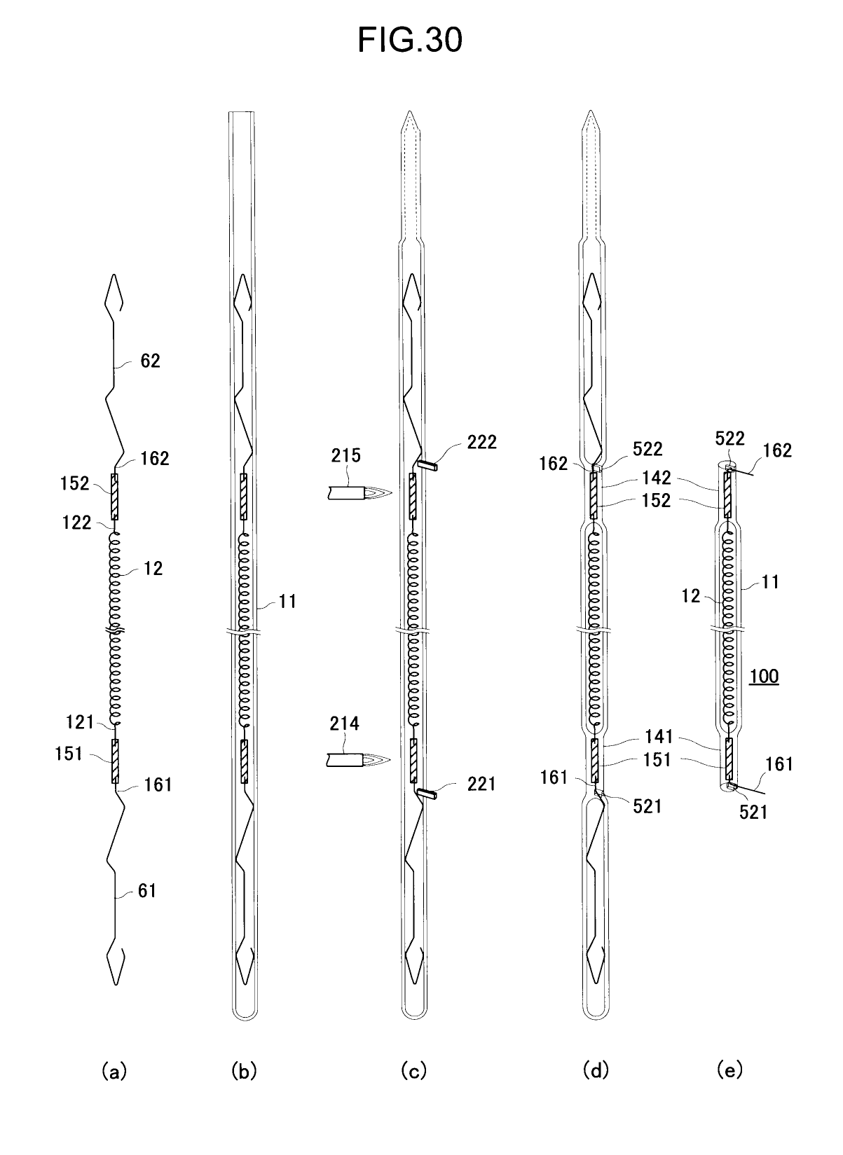

FIG. 30A to FIG. 30E are explanatory views illustrating a fourth embodiment of the halogen lamp production method of the invention. A production method of the halogen lamp described with reference to FIG. 15A and FIG. 15B is described in this embodiment.

First, FIG. 30A shows that the inner leads 121, 122, the metal foils 151, 152 and the outer leads 161, 162 are sequentially connected in series to both ends of the filament 12, respectively. The connection points among one end of the filament 12, the inner lead 121, the metal foil 151 and the outer lead 161 which are serially connected and the connection points among the other end of the filament 12, the inner lead 122, the metal foil 152 and the outer lead 162 which are serially connected are connected by, for example, spot welding, respectively.

In FIG. 30B, the filament 12 and others integrated by connecting in series in FIG. 30A are housed in the bulb 11 with its lower end sealed in advance in the drawing. The state of FIG. 30A can be held in the bulb 11 by the elastic action of the bent portions of the outer leads 161, 162.

In FIG. 30C, a portion of the bulb 11 where the metal foil 151 is positioned is externally melted by a burner 214 using gas to integrate the portion of the bulb 11 and the metal foil 151 by the action of its own weight below the point where the burner 214 is fired to form the sealed portion 141. A metal jig 221 is pushed to the melted sealed portion 141 so as to reach the outer lead 161, and the recess portion 521 where the outer lead 161 is visible through the outer circumferential surface of the bulb 11 is formed (FIG. 30D).

Similarly, a portion of the bulb 11 having the pressure-reduced interior where the metal foil 152 is positioned as shown in FIG. 30C is externally melted by a burner 215 using gas to integrate the portion of the bulb 11 and the metal foil 152 by the action of its own weight below the point where the burner 215 is fired to form the sealed portion 142. A metal jig 222 is pushed toward the melted sealed portion 141 so as to reach the outer lead 162, thereby forming a recess portion 522 where the outer lead 161 is visible through the outer circumferential surface of the bulb 11 (FIG. 30D).

The processes of forming the sealed portions 141, 142 may be performed separately but they can also be configured at the same time. Simultaneous configuration can contribute to improvement of productivity. It is determined whether or not the recess portions 521, 522 are formed at the same time according to whether the processes of the sealed portions 141, 142 are simultaneous or not.

In FIG. 30D, both opening sides of the bulb 11 are cut off by means of, for example, a laser or the like to remain the sealed portions 141, 142, and the outer leads 161, 162 are also cut off to have an appropriate length. The outer leads 161, 162 are bent along the recess portions 521, 522, and the outer leads 161, 162 which are protruded from the outer circumferential surface shown in FIG. 29E can be realized.

A chip protruded by about 1 to 5 mm on the remaining part of the exhaust introduction pipe generated when the gas is encapsulated into the bulb 11 can also be eliminated by encapsulating from the open end of the bulb 11. In such a case, transportability can also be improved because there is no chip which becomes an obstacle at the time of transporting a large number of tubular incandescent discharge lamps.

In the above-described individual embodiments of the halogen lamp, the halogen lamp device, the fixing device and the halogen lamp production method of the invention, both the outer leads of the halogen lamp 100 are externally extended from the outer circumferential surfaces of the sealed portions, but at least one of the outer leads may be externally extended from the sealed portion, if necessary.

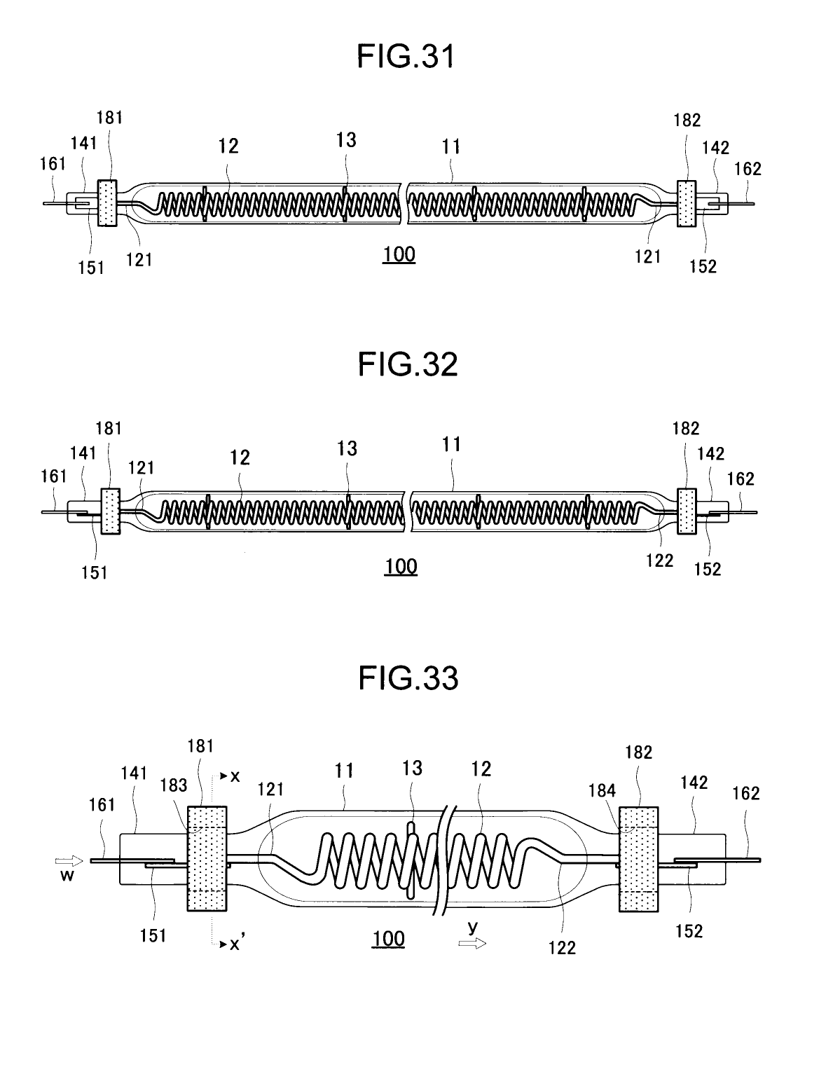

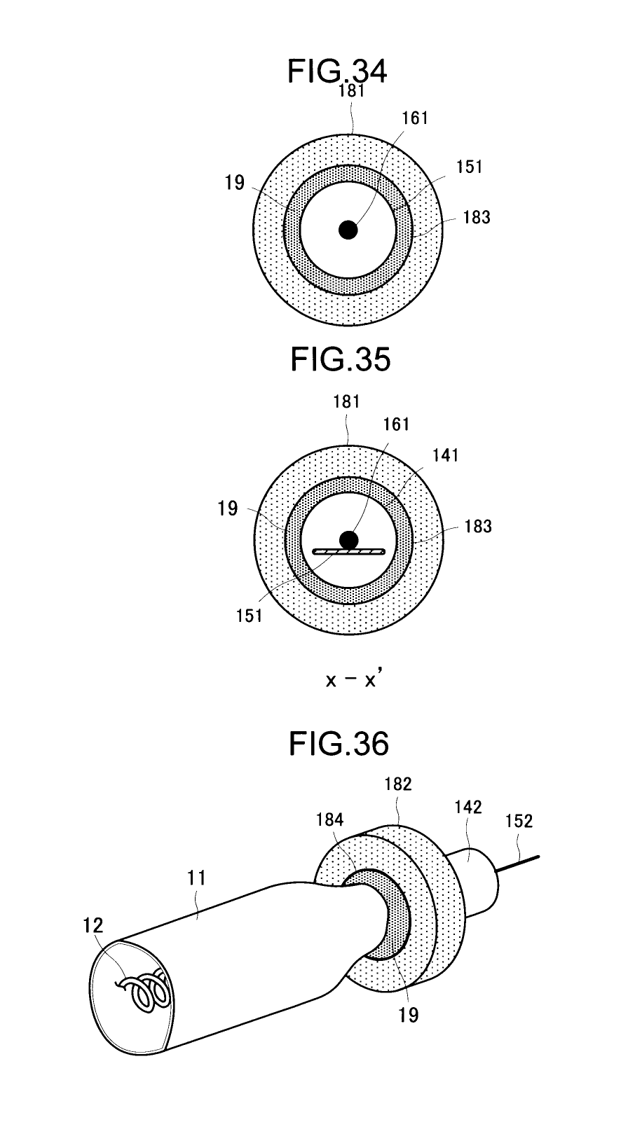

FIG. 31 through FIG. 36 are used to describe a fifth embodiment of the halogen lamp of the invention. FIG. 31 is a front view, FIG. 32 is a side view, FIG. 33 is a front view showing the essential part of FIG. 32 in an enlarged state, FIG. 34 is a front view viewed from a direction of arrow w of FIG. 33, FIG. 35 is an x-x′ sectional view of FIG. 33, and FIG. 36 is a perspective view viewed from a direction of arrow y on the right side of FIG. 33.

The halogen lamp 100 which is a type of tubular incandescent lamp is often used, for example, as a heater for fixing and has a bulb 11 of quartz glass or the like having radioparency. A tungsten coil 12 which is an example of an electric resistance wire made of a refractory metal is housed concentrically as a heat source in the bulb 11. The tungsten coil 12 is held in a concentric state with respect to the bulb 11 by anchors 13 which are arranged in plural in the axial direction within the bulb 11. A required amount of halogen gas is included together with inert gas such as argon within the bulb 11, and sealed portions 141, 142 are formed by sealing in the axial direction of the bulb 11 by reduced-pressure sealing. Rectangular metal foils 151, 152 made of, for example, conductive molybdenum (Mo) having a similar expansion coefficient as the bulb 11 are buried in the sealed portions 141, 142, respectively.

The sealed portions 141, 142 by reduced-pressure can be formed by sealing temporarily the bulb 11 at portions which do not become the sealed portions to provide a state that the bulb 11 interior including the sealed portions are put under reduced pressure, and airtightly sealing the metal foils 151, 152. This sealing is called shrink sealing, and since the sealed portions do not have a thin part, the sealed portions having a considerably high strength can be obtained in comparison with those obtained by the pinch sealing.

One end 121 of the tungsten coil 12 is connected to one end of the metal foil 151, and the other end 122 of the tungsten coil 12 is connected to one end of the metal foil 152. The other end of the metal foil 151 is connected to the outer lead 161 for supplying electric power, and the other end of the metal foil 152 is connected to the outer lead 162 for supplying electric power.

Reference numerals 181, 182 denote cylindrical bases for positioning which are made of, for example, heat-resistant ceramic, and they have a length smaller than the sealed portions 141, 142. The bases 181, 182 are formed to have mounting holes 183, 184 slightly larger than the sealed portions 141, 142 for mounting. The bases 181, 182 are fixed at prescribed positions with an adhesive agent 19 (see FIG. 36) by inserting the sealed portions 141, 142 into the mounting holes 183, 184, respectively.

In this embodiment, the sealed portions 141, 142 under reduced pressure can be directly supported and fixed by brackets. And, since the bases 181, 182 are used for positioning, they contribute to simplification of the halogen lamp mounting structure.

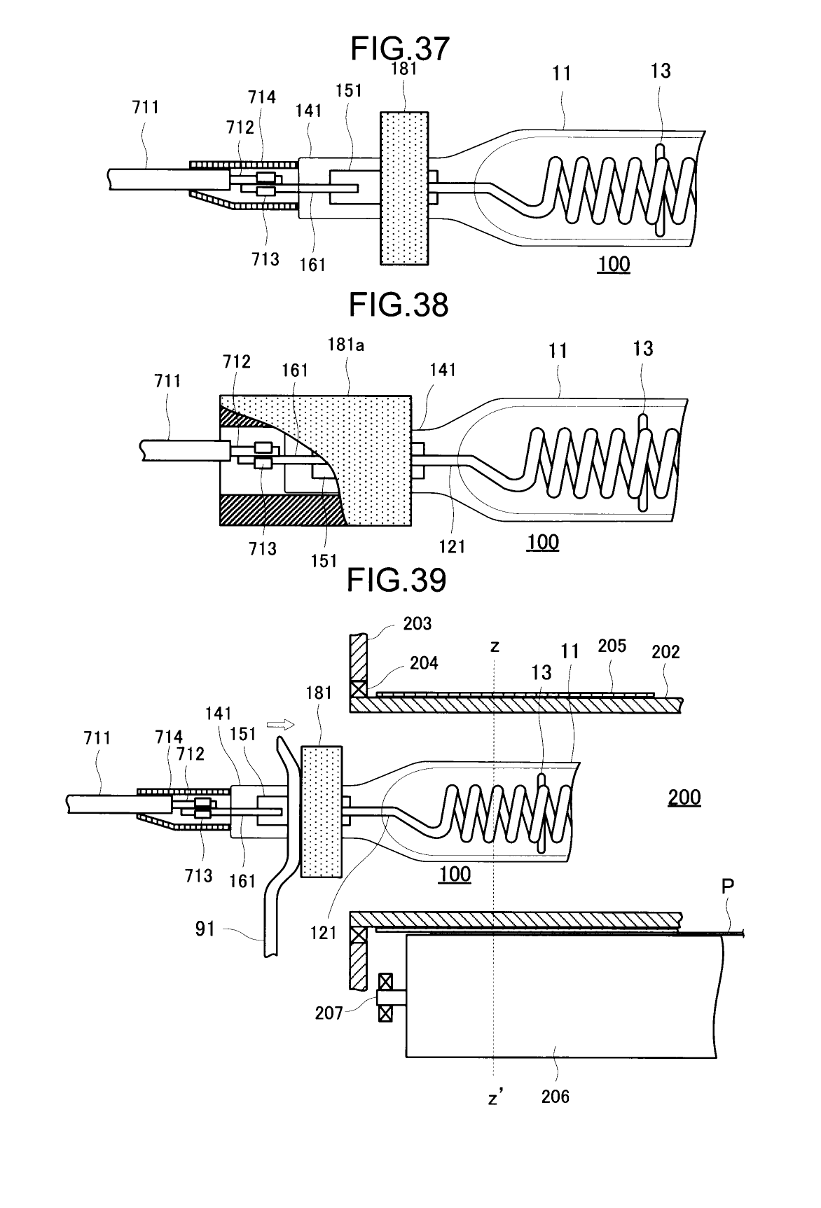

FIG. 37 is a sectional view illustrating an example of connection with an electric wire for feeding power to the halogen lamp of the invention. FIG. 37 shows the sealed portion 141 side of the halogen lamp 100.

Specifically, the outer lead 161 externally extended from the sealed portion 141 is electrically and mechanically connected by compression-bonding a sleeve 713 which is inserted together with a core wire 712 of a coated electric wire 711 that supplies electric power. The connection between them is electrically protected with an insulating coating 714.

FIG. 38 is a sectional view illustrating another example of the connection with an electric wire for feeding power to the halogen lamp of the invention. In FIG. 38, the sealed portion 141 side of the halogen lamp 100 is shown in the same manner as in FIG. 37, and like component parts corresponding to those of FIG. 37 are denoted by like reference numerals, and their descriptions are omitted.

In this example, a base 181a is formed to have a long shape, so that the outer lead 161 is hidden when the base 181a is inserted onto the sealed portion 141. Thus, the electrically and mechanically connected portion between the outer lead 161 and the core wire 712 of the coated electric wire 711 can be protected electrically without the insulating coating 714 of FIG. 37.

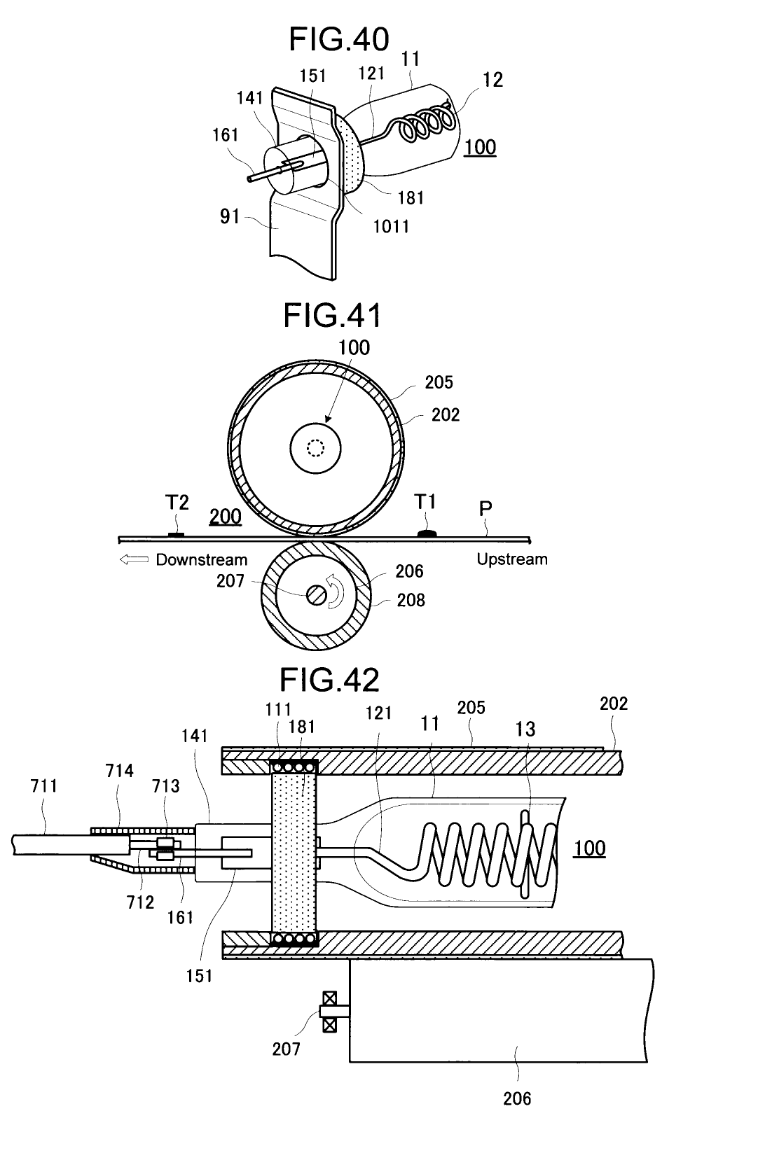

FIG. 39 through FIG. 41 are used to describe a first embodiment of the fixing device of the invention when the halogen lamp of FIG. 37 is used. FIG. 39 is a sectional view showing a schematic structure, FIG. 40 is a perspective view of the essential part of FIG. 39, and FIG. 41 is a z-z′ sectional view of FIG. 39.

In this embodiment, the halogen lamp 100 described with reference to FIG. 37 is fixed to a fixing device 200, which fixes a toner of a copy machine or the like, by means of a fixing means.

In FIG. 39, 91 denotes a bracket whose one end is fixed to an unshown chassis or the like. As shown in FIG. 40, the bracket 91 is provided with an engagement hole 1011 for insertion of the sealed portion 141. The bracket 91 may be attached in a state that the base 181 is pushed in the direction indicated by the arrow in the figure by its elasticity. And, the base 181 may have a shape to be supported by the bracket 91.

The halogen lamp 100 is supported by the bracket 91 so as to be arranged within a cylindrical heating roller 202 of the fixing device 200. The heating roller 202 is freely rotatably supported by a frame 203 via a bearing 204. The heating roller 202 has a tubular body made of a material such as aluminum, iron or the like, and its surface is coated with a coating material 205 such as silicone rubber, Teflon (registered trademark) or the like.

Reference numeral 206 denotes a pressure roller which is freely rotated by a rotating shaft 207 and has a tubular body made of a material such as aluminum, iron or the like. And, its surface is provided with a heat resistant elastic material such as silicone rubber 208.

The halogen lamp 100 is supported by the bracket 91 so as to be arranged on a substantially central axis of the heating roller 202. When it is connected to an unshown power source and energized, the tungsten coil 12 of the halogen lamp 100 is caused to generate heat, and the heating roller 202 is heated (has an increased temperature).

As shown in FIG. 41, when a copying paper P on which toner T1 is transferred in a prescribed distributed state from an unshown transfer drum or the like is rotated in the direction indicated by an arrow, it is delivered between the heated heating roller 202 and the pressure roller 206, the copying paper P and the toner T1 coated in the previous step are heated, and the heated toner T2 is fused and fixed onto the copying paper P as prescribed characters, patterns and the like.

To support the halogen lamp 100 by the bracket 91, either the sealed portion 141 or the base 181 may be used.

In this embodiment, since it is possible to attach the halogen lamp provided with a positioning base by simply supporting it by the bracket of the fixing device, it is possible to considerably decrease the size of the heating roller for fixing and it also contributes to downsizing of the heating roller.

FIG. 42 is a sectional view showing a schematic structure illustrating a second embodiment of the fixing device of the invention. In this embodiment, the structure of the portion having integrated the support of the heating roller 202 and the halogen lamp 11 is different from FIG. 39. For description, like component parts corresponding to those of FIG. 39 are denoted by like reference numerals.

In FIG. 42, the cylindrical heating roller 202 is arranged on the outer circumference of a positioning base 181. The outer circumference of the base 181 is supported by a bearing 111 which is attached to the inner circumferential wall of the heating roller 202. Thus, the heating roller 202 becomes freely rotatable about the outer circumference of the fixed base 181. A support for the halogen lamp 100 is not shown, but the sealed portion 141 may be supported by a chassis or the like via a bracket.

In FIG. 42, for electrical protection, the insulating coating 714 is used at the electrically and mechanically connected portion of the outer lead 161 and the core wire 712 of the coated electric wire 711, but the insulating coating 714 may be omitted by positioning the connected portion on the inner circumference of the heating roller 202.

In this embodiment, the halogen lamp which is attached to the base in a necessary property state as a fixing heater for a heat distribution and the like has a heating heater which is freely rotatably attached to the outer circumference of the base. Therefore, it becomes possible to realize saving of a space while possessing the conditions of a halogen lamp optimum as the heater.

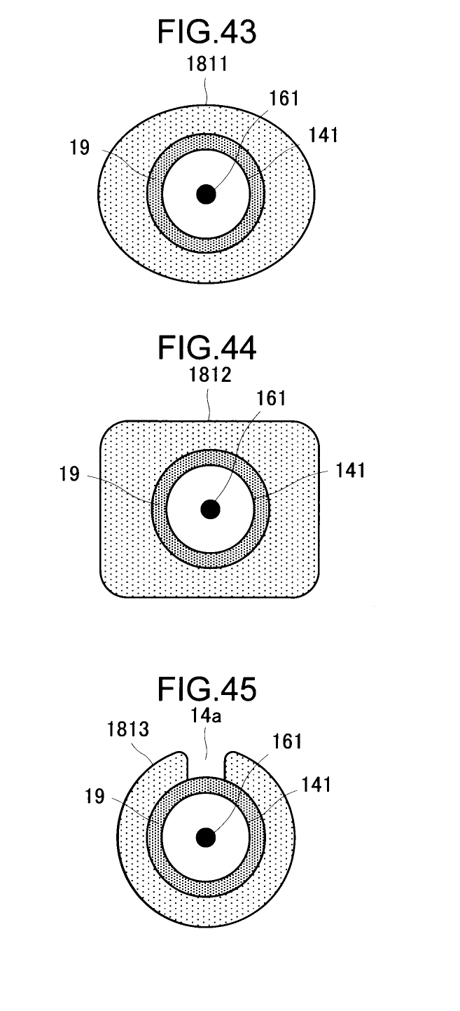

FIG. 43 to FIG. 48B are sectional views illustrating first to sixth modified embodiments of the fifth embodiment of the halogen lamp of the invention. The first and second modified embodiments are variations of the shape of the base to be attached to the halogen lamp.

FIG. 43 shows a base 1811 having an elliptic columnar shape, and FIG. 44 shows a base 1812 having a square columnar shape. Thus, when it is determined to have a columnar shape other than a semicircular columnar shape, the bracket 91 can be prevented from rotating or twisting when attached by having a shape matching the base.

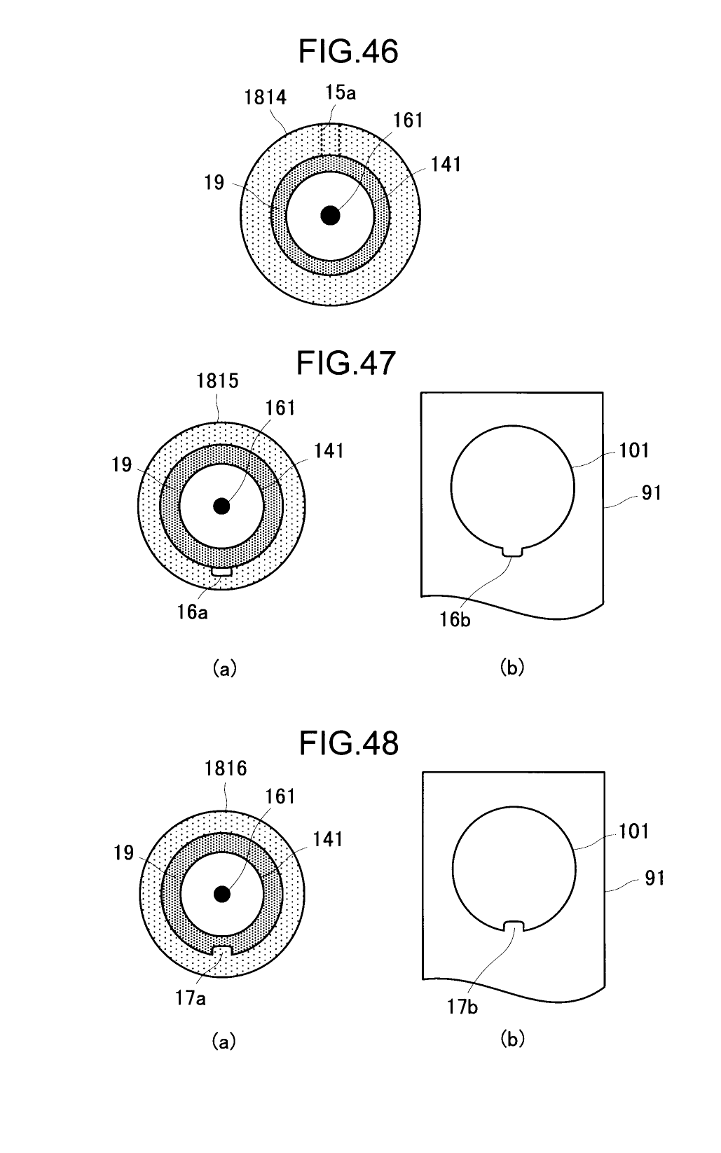

FIG. 45 and FIG. 46 show that it is facilitated to pour the adhesive agent 19 to fix with the sealed portion. FIG. 45 shows that a slit 14a is formed in a base 1813, and FIG. 46 shows that an injection hole 15a is formed in a base 1814. Thus, the work of injecting the adhesive agent 19 is improved, and the adhesive agent 19 is stably held between the base and the sealed portion.

FIG. 47A to FIG. 48B show that the bracket 91 is shaped to mach the base, so that rotation or twisting when attached can be prevented. In FIG. 47A and FIG. 47B, a recess portion 16a is formed in a base 1815, and a projected portion 16b which is engaged with the recess portion 16a is formed in the bracket 91. In FIG. 48A and FIG. 48B, a projected portion 17a is formed in a base 1816, and a recess portion 17b which is engaged with the projected portion 17a is formed in the bracket 91.

In addition to the above-described first to seventh modified embodiments, the base may have a contour which is polygonal, such as a triangular column, a quadratic column or the like. Besides, the bracket may be formed to have a shape to support the sealed portion and the base at the same time.

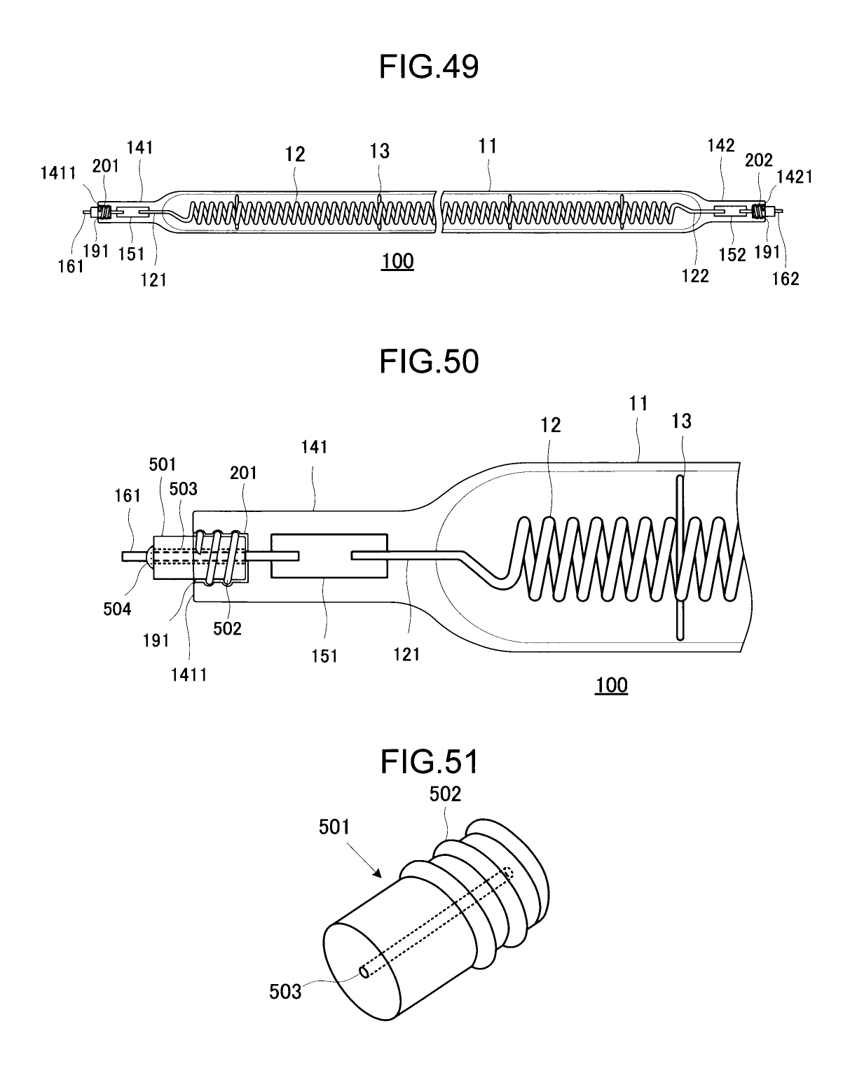

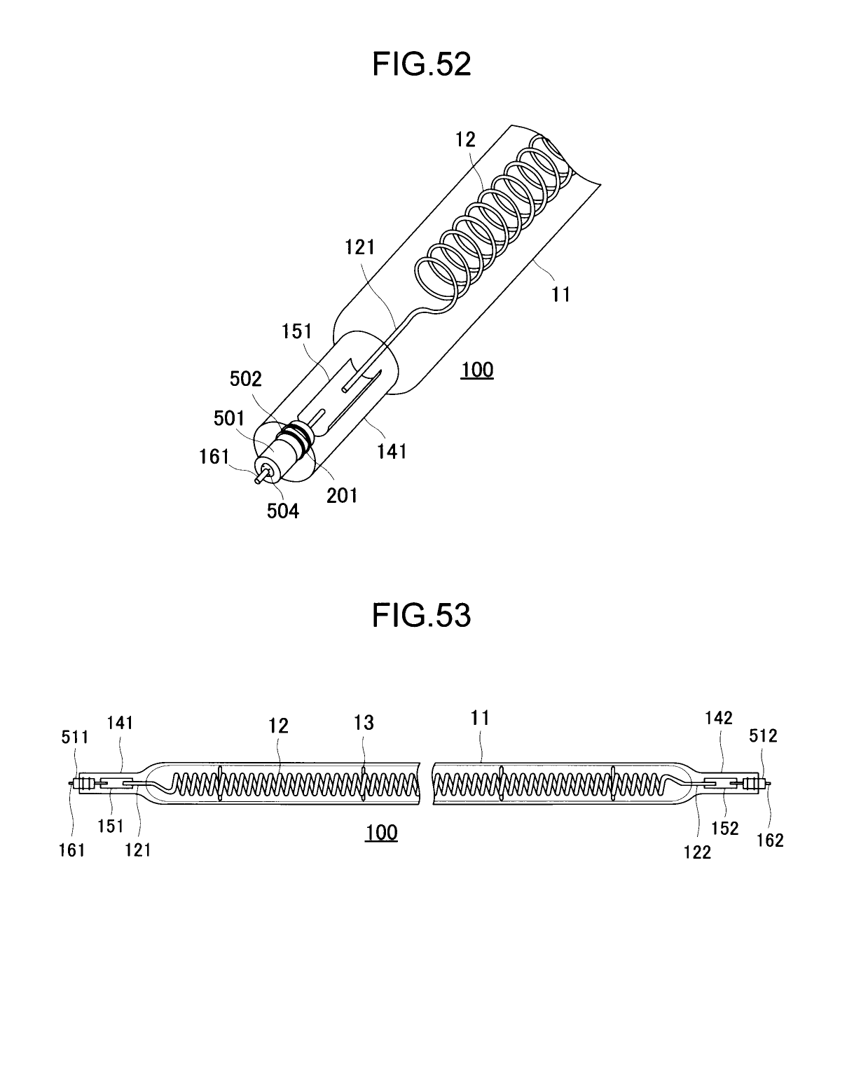

FIG. 49 to FIG. 52 are used to describe a sixth embodiment of the heater lamp of the invention. FIG. 49 is a configuration view, FIG. 50 is an enlarged view of the essential part of FIG. 1, FIG. 51 and FIG. 52 are perspective views illustrating the essential part of FIG. 1 in an enlarged state.

In FIG. 49 and FIG. 50, the halogen lamp 100 has a bulb 11 of quartz glass or the like which is often used, for example, as a heater for fixing and has radioparency. A tungsten filament 12 which is an example of an electric resistance wire made of a refractory metal is housed concentrically as a heat source in the bulb 11. The filament 12 is held in a concentric state with respect to the bulb 11 by anchors 13 which are arranged in plural in the axial direction within the bulb 11. In the bulb 11, inert gas such as argon Ar or nitrogen N₂ is sealed under pressure of about 0.9×10⁵ Pa (Pascal) at normal temperature of 25° C. together with a mixture of a very small amount of halogen substances such as bromine Br and chlorine Cl. At both ends of the bulb 11 in the axial direction, sealed portions 141, 142 are formed by reduced-pressure sealing. Rectangular metal foils 151,152 made of, for example, conductive molybdenum (Mo) having a similar expansion coefficient as the bulb 11 are buried in the sealed portions 141, 142, respectively.

Here, the reduced-pressure sealing is a sealing method which is called shrink sealing and seals temporarily the lamp at portions other than the sealed portions and airtightly seals the molybdenum foil with the lamp interior including the sealed portion under reduced pressure. This sealing method can improve the strength of the sealed portions because the quartz glass thickness is not deviated as in a case of the sealing method based on pinch sealing.

One end of the metal foil 151 is connected to one end of the inner lead 121 whose other end is connected to the filament 12, and one end of the metal foil 152 is connected to one end of the inner lead 122 whose other end is connected to the filament 12. The other end of the metal foil 151 is connected to the outer lead 161 for supplying electric power, and the other end of the metal foil 152 is connected to the outer lead 162 for supplying electric power.

An end surface 1411 of the sealed portion 141 and an end surface 1421 of the sealed portion 142 have therein a recess portion 191 having each of the outer leads 161, 162 arranged at the center as shown in FIG. 50, and female threads 201, 202 each are formed in the inner circumferential wall of the recess portion 191.

Reference numeral 501 denotes a base member which has a male thread formed on its conductive outer circumference. As shown in FIG. 51, a thread 502 which is engaged with female threads 201, 202 is formed on the outer circumference of the base member 501. And, a through hole 503 for freely fitting the outer lead 161 (162) is formed in the center of the base member 501 in the longitudinal direction. The base member 501 is inserted onto the outer lead 161 (162) and also screwed together with the female thread 201 (202) so as to be screwed into the state shown in FIG. 52. Thus, it is attached to the sealed portion 141 (142). To keep the electrically and mechanically attached state stably, the base member 501 and the outer lead 161 (162) are mutually adhered with an adhesive agent 504.

Electric power is supplied to the base member 501, so that the filament 12 is caused to generate heat and can be used as a halogen lamp for fixing. The base member 501 which becomes a base member for feeding electric power can be made smaller than the contours of the sealed portions 141, 142, and it can contribute to saving of a space for the power supply portion of the halogen lamp. It is to be understood that the relation between the male thread and the female thread may be opposite.

In this embodiment, since the structure to supply electric power to the halogen lamp can be made compact, the system using this halogen lamp can be made compact. By accurately determining a position where the thread is cut in the sealed portion, positioning of the screw fitted to the thread can be improved, and the product quality is also improved.

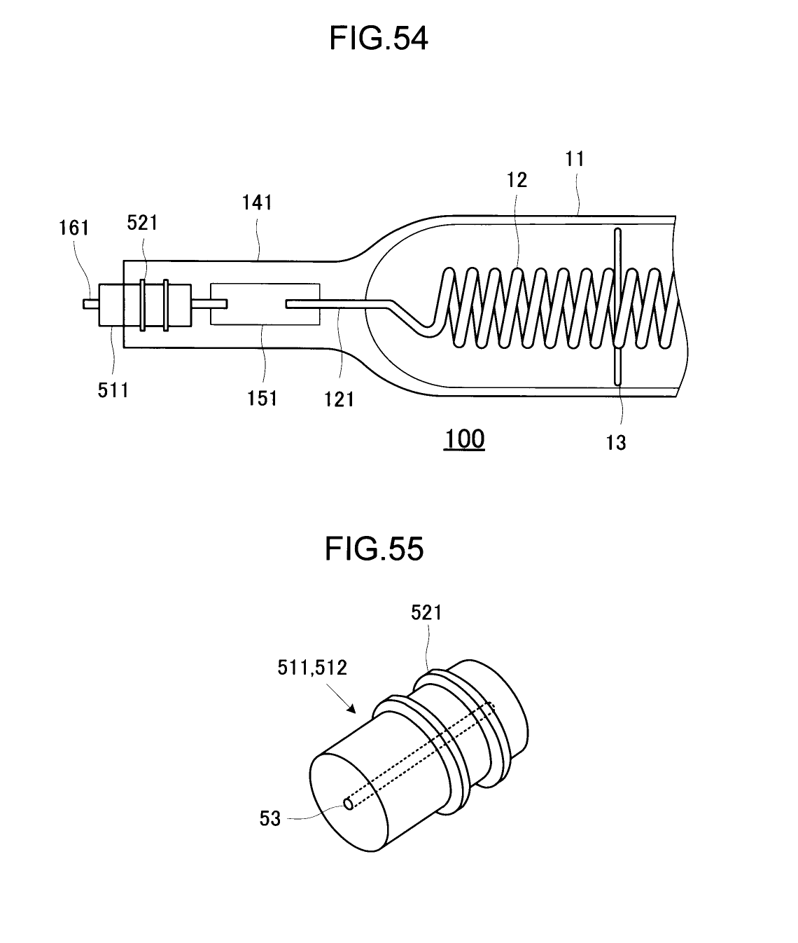

FIG. 53 to FIG. 55 are used to describe a seventh embodiment of the heater lamp of the invention. FIG. 53 is a configuration view, FIG. 54 is an enlarged view of the essential part of FIG. 53, and FIG. 55 is a perspective view illustrating the essential part of FIG. 53 in an enlarged state. For description, like component parts corresponding to those of the halogen lamp 11 of FIG. 49 are denoted by like reference numerals

In this embodiment, conductive base members 511, 512 are partly buried in the sealed portions 141, 142 of the halogen lamp 11. Flanges 5021 are integrally formed on the outer circumferences of the base members 511, 512 as shown in FIG. 55 to prevent the base members from coming out of the sealed portions 141, 142. In addition, a through hole 503 for extending the outer leads 161, 162 is formed in the base members 511, 512.

As shown in FIG. 54, when the sealed portion 141 (142) is formed, the base member 511 (512) comes into a state that it is partly sealed with the glass which is a material of the sealed portion 141 (142). Therefore, the sealed portion 141 (142) can be provided with a mechanical strength.

In addition to the effects provided by the seventh embodiment of the heater lamp of the invention, this embodiment can improve the accuracy of positioning of the base member against a sealing member and can improve the quality furthermore. And, when the sealed portion is formed, the base member can also be attached at the same time. Thus, improvement of productivity is also expected.

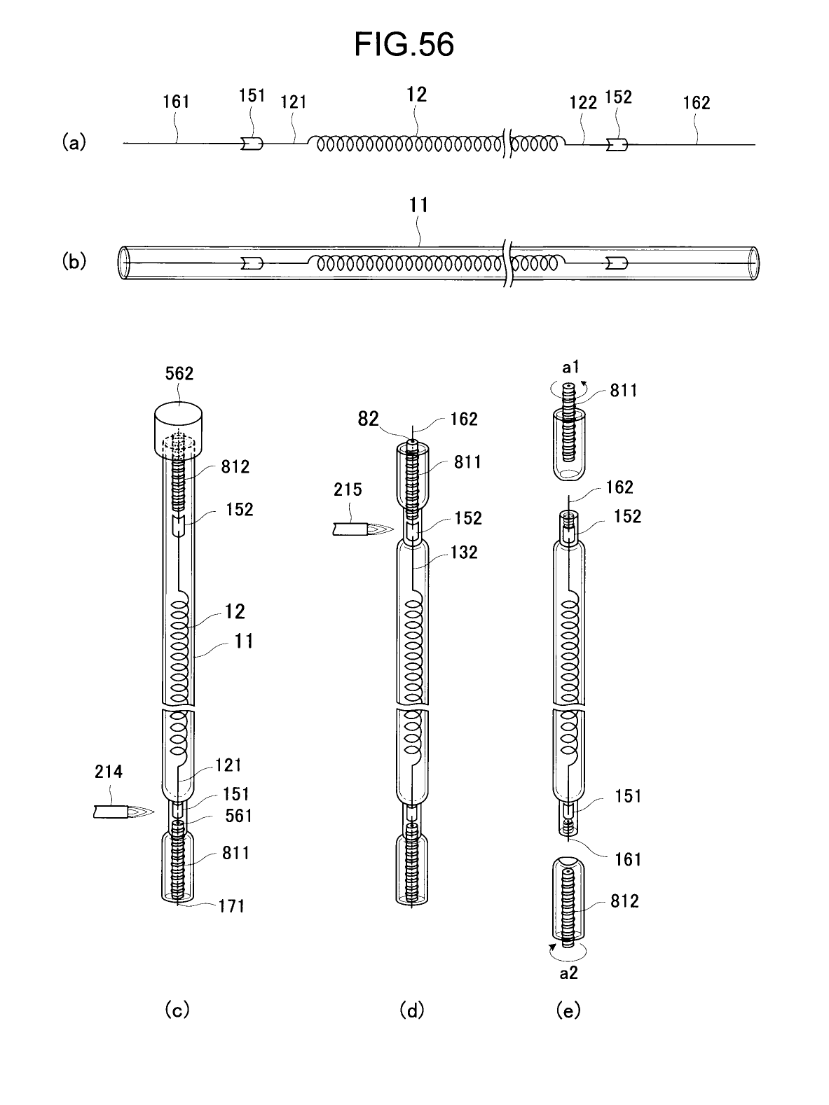

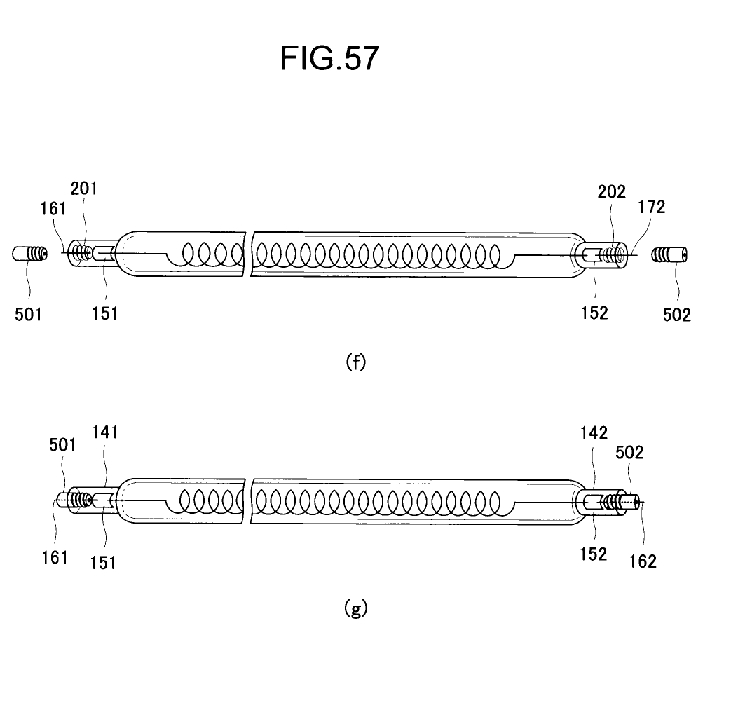

Referring to FIG. 56A to FIG. 57G, one embodiment of the production method for realization of the heater lamp of the invention described with reference to FIG. 49 is described below.

First, the inner leads 121, 122, the metal foils 151, 152 and the outer leads 161, 162 are connected in series to both ends of the filament 12 as shown in FIG. 56A. The connection points among one end of the filament 12, the inner lead 121, the metal foil 151 and the outer lead 161 which are serially connected and the connection points among the other end of the filament 12, the inner lead 132, the metal foil 152 and the outer lead 162 which are serially connected are connected by, for example, spot welding, respectively.

In FIG. 56B, the filament 12 and others connected in series and integrated in FIG. 56A are housed into the bulb 11.

In FIG. 56C, Seed screws 811, 812 for forming the female threads 201, 202 are temporarily attached into the bulb 11 with the outer leads 161, 162 inserted through individual through holes 561 formed in the Seed screws 811, 812. In addition, a cap 562 is attached to one end of the bulb 11 configured to have the state shown in FIG. 56B. The outer lead 162 is also attached to the cap 562. The cap 562 is held at the top side, the bulb 11 having the pressure-reduced interior where the metal foil 151 and the Seed screw 811 on the side of the metal foil 151 are positioned is melted externally by a gas burner 214, and the bulb 11 and the metal foil 151 are integrated to form the sealed portion 141 based on the action of its own weight below the bulb 11 to which the burner 214 is fired. The Seed screw 811 is also sealed partly at the same time.

Here, the cap 562 was used to temporarily secure the outer lead 162, but it may be configured to form the anchors on the outer lead and to support the anchors within the bulb 11.

Similarly, in FIG. 56D, the bulb 11 having the pressure-reduced interior where the metal foil 152 and the Seed screw 812 on the side of the metal foil 152 are positioned is melted externally by a gas burner 215. The bulb 11 and the metal foil 152 are integrated to form the sealed portion 142 based on the action of its own weight below the bulb 11 to which the burner 215 is fired. The Seed screw 812 is also sealed partly at the same time.

In FIG. 56E, the Seed screw 811 is turned in the direction of arrow a1 and the Seed screw 812 is turned in the direction of arrow a2 before the sealed portions 141, 142 are cured to remove them, thereby forming female threads 201, 202. Both open sides of the bulb 11 are cut off by means of, for example, a laser or the like to remain the sealed portions 141, 142, and the outer leads 161, 162 are also cut off to have an appropriate length.

In FIG. 57F, the previously formed base members 501, 502 are screwed into the female threads 201, 202 formed in the step of FIG. 56E, while the outer leads 161, 162 are inserted into the through hole 53. Thus, the base members 501, 502 can be attached. Then, the base member 501 and the outer lead 161 and the base member 501 and the outer lead 162 are electrically connected respectively to complete the halogen lamp of FIG. 57G.

In the steps of FIG. 56C and FIG. 56D, it is also possible to operate the burners 214, 215 at the same time. Then, it becomes possible to decrease the sealing time and to improve the mass-production effect.

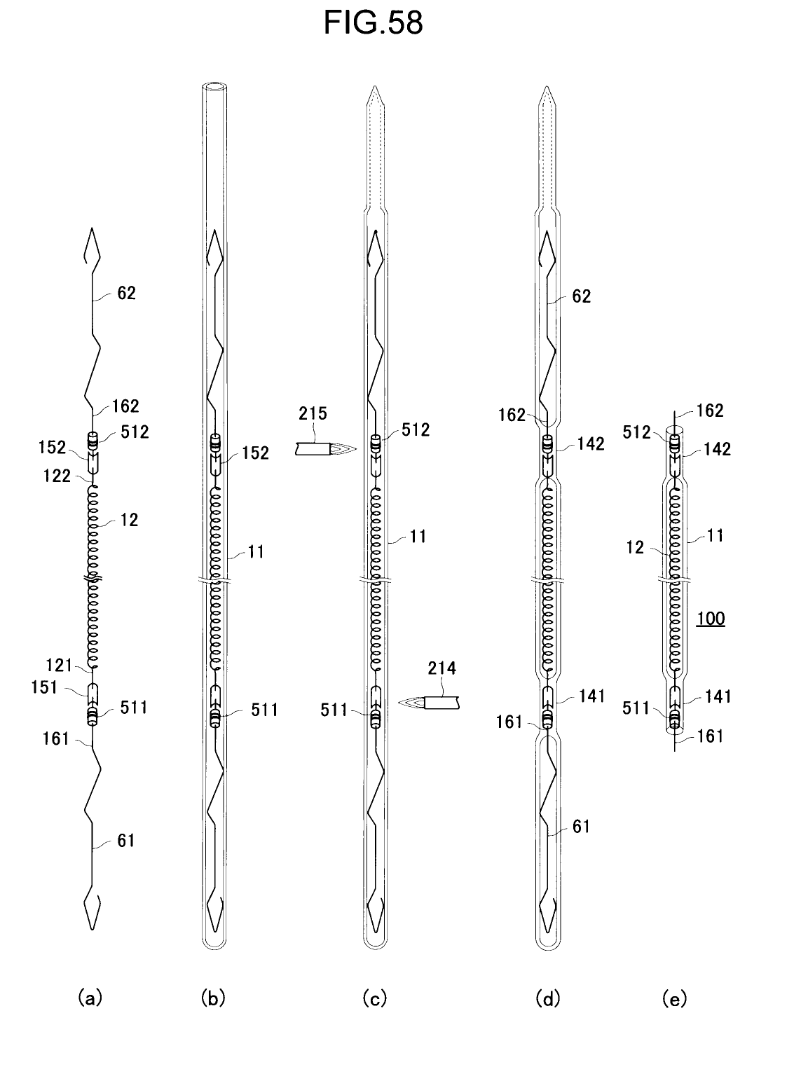

Referring to FIG. 58A through FIG. 58E, another embodiment of the production method of the heater lamp of the invention described with reference to FIG. 53 is described below.

First, the inner leads 121, 122, the metal foils 151, 152, the base members 511, 512 and the outer leads 161, 162 having bent portions are connected in series to both ends of the filament 12 as shown in FIG. 58A. Portions to connect the inner lead 121, the metal foil 151, the base member 511 and the outer lead 161 in series to one end of the filament 12 are connected by, for example, spot welding, respectively. Similarly, portions to connect the inner lead 132, the metal foil 152, the base member 512 and the outer lead 162 in series to the other end of the filament 12 are connected by, for example, spot welding, respectively.

Then, in FIG. 58B, the filament 12 and others connected in series and integrated in FIG. 58A are housed into the bulb 11. The bent portions of the outer leads 161, 162 are in an elastically contacted state against the interior of the bulb 11 when moved and hold the state as shown in FIG. 58B.

In FIG. 58C, a portion of the bulb 11 where the metal foil 151 is positioned is melted externally by the gas burner 214. In FIG. 58D, the portion of the bulb 11 and the metal foil 151 are integrated to form the sealed portion 141 based on the action of its own weight below the bulb 11 to which the burner 214 is fired.

Similarly, a portion of the bulb 11 where the metal foil 152 is positioned is melted externally by the gas burner 215. The portion of the bulb 11 and the metal foil 152 are integrated to form the sealed portion 142 based on the action of its own weight below the bulb 11 to which the burner 215 is fired.

In the steps of FIG. 58C and FIG. 58D, the sealed portions 141, 142 are formed at the same time by the burners 214, 215 but may be formed by separate steps.

In FIG. 58E, both open sides of the bulb 11 are cut off by means of, for example, a laser or the like, and the outer leads 161, 162 are also cut off to have an appropriate length while the sealed portions 141, 142 are remained, and the base members 511, 512 are partly protruded in the longitudinal direction of the sealed portions 141, 142. Thus, the production of the halogen lamp of FIG. 53 is accomplished.

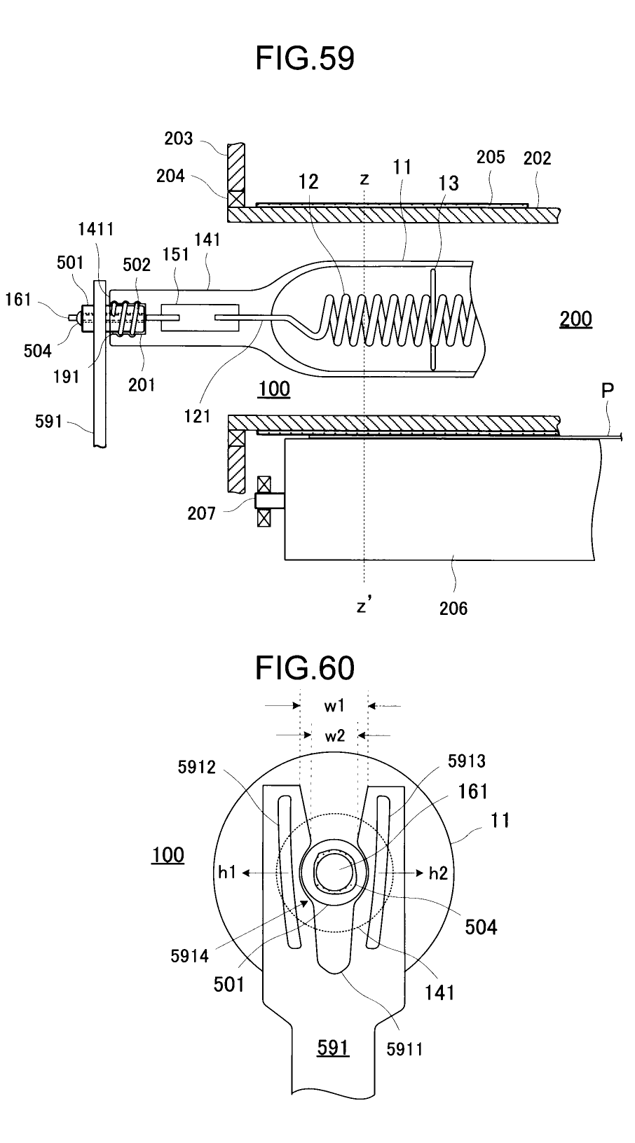

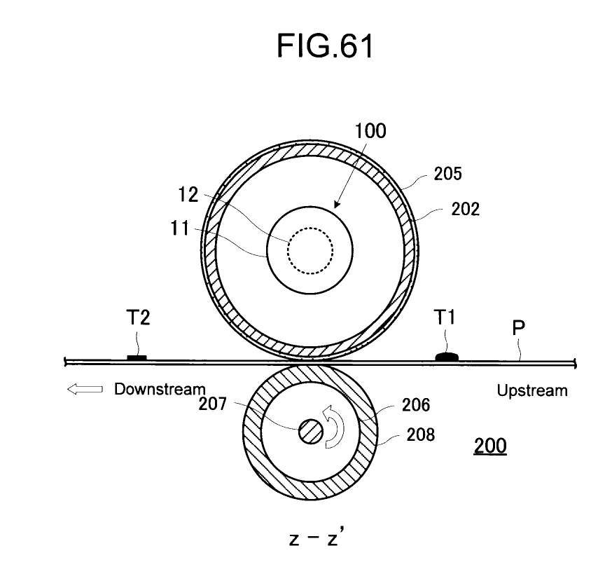

FIG. 59 to FIG. 61 are used to describe one embodiment of a fixing device using the heater lamp of the invention described with reference to FIG. 49. FIG. 59 is a configuration view showing a schematic structure, FIG. 60 is a side view illustrating the attachment of the tubular incandescent lamp of FIG. 59, and FIG. 61 is a z-z′ sectional view of FIG. 59.

This embodiment uses the halogen lamp 11 of the invention for a fixing device 200 which fixes a toner of a copy machine or the like, and FIG. 59 shows a state that the halogen lamp 11 having the left side of FIG. 49 shown in an enlarged state is attached to the fixing device 200.

In FIG. 59, 591 denotes a bracket whose one end is fixed to a chassis or the like. The other end of the bracket 591 catches the base member 51 of the halogen lamp 11. The bracket 591 is made of, for example, a conductive metal plate and configured to supply electric power directly.

The bracket 591 is provided with a cutout 5911 in its tip end as shown in FIG. 60 and also provided with slits 5912, 5913 along both sides of the cutout 5911 with a predetermined space from both sides of the cutout 5911. The entrance of the cutout 5911 has a width w1, which is larger than an outer diameter of a portion protruded from the sealed portion of the base member 501 and becomes smaller gradually, and a holding portion 5914 which is slightly smaller than the diameter of the base member 501 is formed by the opposed side surfaces at the middle of the cutout 5911. The entrance of the holding portion 5914 has a width w2 which is smaller than an outer diameter of the portion protruded from the sealed portion of the base member 501.

When the base member 501 is inserted into the cutout 5911, the base member 501 hits both side surfaces of the cutout 5911 before the holding portion 5914 which is smaller than its diameter. When the base member 501 is further pushed against it to enter deep into the cutout 5911, the side surfaces of the cutout 5911 are widened in directions of arrows h1, h2 toward the slits 5912, 5913, and the base member 501 is held by the holding portion 5914. After the base member 501 has passed through the both side surfaces of the cutout 5911 which is smaller than it, the base member 501 is surely held by the action of returning to the original shape.

Electric power can be supplied to the halogen lamp 11 when the base member 501 is simply attached to the bracket 591. The halogen lamp 11 is arranged substantially at the center position within the cylindrical heating roller 202 of the fixing device 200 when attached to the bracket 591. The heating roller 202 is freely rotatably supported by the frame 203 via the bearing 204.

As shown in FIG. 61, the heating roller 202 has a tubular body made of a material such as aluminum, iron or the like, and its surface is coated with a coating material 205 such as silicone rubber, Teflon (registered trademark) or the like. Reference numeral 206 denotes a pressure roller which is freely rotated by a rotating shaft 207 and has a tubular body made of a material such as aluminum, iron or the like. And, its surface is provided with a heat resistant elastic material such as silicone rubber 208.

To position on a substantially central axis of the heating roller 202, the halogen lamp 11 is arranged by supporting by the bracket 591. When connected to an unshown power source to supply electric power, the filament 12 of the halogen lamp 11 is caused to generate heat, and the heating roller 202 is heated.

As shown in FIG. 61, when a copying paper P on which toner T1 is transferred in a prescribed distributed state from an unshown transfer drum or the like is rotated in the direction indicated by an arrow, it is delivered between the heated heating roller 202 and the pressure roller 206, the copying paper P and the toner T1 coated in the previous step are heated, and the heated toner T2 is fused and fixed onto the copying paper P as prescribed characters, patterns and the like.

In this embodiment, since a structure electrically supporting a compact base member for supplying electric power to the sealed portion could be realized, downsizing of the fixing device as a whole can be realized.

### INDUSTRIAL APPLICABILITY

The invention relates to a halogen lamp which is provided with an electrical resistance heating element within a radioparent bulb and has a sealed portion formed under reduced pressure, and it is suitably used for fixing in, for example, a copy machine.

1. A halogen lamp, comprising:
a tungsten filament inserted into a bulb made of heat-resistant glass,
a pair of metal foils whose one ends are connected to both ends of the filament respectively, and
outer leads for electric power supply connected to the other ends of the individual metal foils with the bulb portions corresponding to the metal foils sealed by a reduced-pressure sealing method,
wherein an amount of the glass at the portions corresponding to the metal foils is increased, and a cross section c1 of the bulb portion where the filament is housed and a glass cross section c2 of the portion where the metal foil is sealed by the bulb satisfy a relation of c1<c2.

2. The halogen lamp according to claim 1,
wherein the glass increased in amount at the sealed portions is within the bulb.

3. The halogen lamp according to claim 1,
wherein the glass increased in amount at the metal foils is outside of the bulb.

4. The halogen lamp according to claim 2,
wherein the glass increased in amount at the metal foils is large on the side opposed to the surfaces of the metal foils, and the sealed portions are made to have a cross-sectional shape more closer to a circle.

5. The halogen lamp according to claim 2,
wherein it is determined that the bulb has an outer diameter D, the sealed portions have an outer diameter d and the metal foils have a width L, and the outer diameter d of the sealed portions satisfies a relation of 1.4 L<d<D.

6. A method for producing a heater lamp, comprising:
connecting inner leads, metal foils and outer leads in a series state to both ends of a filament;
housing heat-resistant glass sleeves in a state positioned at the metal foils;
supporting the filament and others connected in series in the previous step together with the sleeves in a cylindrical bulb made of heat-resistant glass;
sealing the metal foils and the sleeves by firing by burners with the bulb interior in a pressure-reduced state; and
cutting the bulb portions located outside of the sealed portions formed in the previous step and the outer leads positioned outside of the bulb to an appropriate length.

7. A method for producing a heater lamp, comprising:
connecting inner leads, metal foils and outer leads in a series state to both ends of a filament;
arranging heat-resistant glass sleeves on the outer circumferential surfaces of a bulb portion at the metal foils;
sealing the sleeves and the bulb portion at the metal foils by firing by burners with the bulb interior in a pressure-reduced state;
cutting the bulb portion located outside of the sealed portions formed in the previous step and the outer leads positioned outside of the bulb to an appropriate length; and
inserting sleeves made of the same glass as the bulb onto the portions sealed in the previous step and firing the sleeves and the bulb by burners to obtain sealed portions having a desired outer diameter.

8. A halogen lamp, comprising:
a coil-shaped filament housed into a cylindrical bulb made of heat-resistant glass;
a pair of metal foils electrically connected from both ends of the filament through inner leads;
externally extended outer leads for electric power supply connected to the other ends of the metal foils; and
reduced-pressure sealed portions having the bulb portions at the metal foil portions sealed by a reduced-pressure sealing method,
wherein at least one of the outer leads is externally extended from the outer circumferential surfaces of the reduced-pressure sealed portions.

9. The halogen lamp according to claim 8,
wherein the outer leads externally extended from the outer circumferential surfaces of the reduced-pressure sealed portions are extended in mutually different directions.

10. The halogen lamp according to claim 8,
wherein the outer leads are bent toward recess portions formed from open ends to insides of the reduced-pressure sealed portions and externally extended from the outer circumferential surfaces of the reduced-pressure sealed portions.

11. A halogen lamp device, comprising:
the halogen lamp according to claim 8;
conductive metal fittings having a mounting hole connected to the outer leads of the halogen lamp; and
a support unit for supporting the metal fittings.

12. A halogen lamp device, comprising:
the first and second halogen lamps according to claim 8 which are arranged in parallel to each other;
first and second metal fittings each having a conductive mounting hole connected to the outer leads externally extended in mutually opposite directions from the sealed portions at opposed positions of the first and second halogen lamps;
a third metal fitting having a conductive mounting hole connected to the outer leads externally extended in opposed directions from the sealed portions at the opposed positions of the first and second halogen lamps; and
a support unit for supporting the first to third metal fittings.

13. A fixing device, comprising:
first and second rollers which are vertically arranged and at least one of which is heated;
the halogen lamp device according to claim 11 arranged within the first or second roller; and a unit for fixing a toner by moving a copy sheet, on which the toner is previously transferred, between the first and second rollers.

14-30. (canceled)
